(19) United States
(12) Patent Application Publication
(10) Pub. No.: US 2025/0173100 A1
(43) Pub. Date: May 29, 2025

(54) COMMUNICATION DEVICE, COMMUNICATION SYSTEM, AND STORAGE MEDIUM STORING COMPUTER PROGRAM

(71) Applicant: BROTHER KOGYO KABUSHIKI KAISHA, Nagoya (JP)

(72) Inventors: Takuya INOUE, Nagoya (JP); Kyohei MORI, Nagoya (JP)

(21) Appl. No.: 18/921,620

(22) Filed: Oct. 21, 2024

(30) Foreign Application Priority Data
Nov. 29, 2023 (JP) 2023-201492

(51) Int. Cl. G06F 3/12

(52) U.S. Cl. CPC G06F 3/1237; G06F 3/1203; G06F 3/1224; G06F 3/1285

(57) ABSTRACT

In a case where the communication device is in an online state, a controller of a communication device receives, via a communication interface, target data transmitted from an external device by a first communication method which is push-type communication. In a case where the communication device transitions from an offline state to the online state, the controller transmits, via the communication interface, a request signal to the external device by a second communication method which is pull-type communication. The controller receives, via the communication interface, the target data from the external device as a response to the request signal by the second communication method. The controller determines whether there is unreceived target data in the external device. Until determining that there is no unreceived target data in the external device, the controller repeats transmitting the request signal to the external device by the second communication method.

### REFERENCE TO RELATED APPLICATIONS

This application claims priority from Japanese Patent Application No. 2023-201492 filed on Nov. 29, 2023. The entire content of the priority application is incorporated herein by reference.

### BACKGROUND ART

An instant message service system used for message exchange between mobile phones is known.

### SUMMARY

In an instant message service system, for example, it is considered that push-type communication and pull-type communication are used together to reduce extra communication.

However, communication states of mobile phones may need to be considered. For example, when the communication state changes, for example, when the mobile phone is temporarily offline, reliability of data transmission to the mobile phone may be insufficient.

In view of the foregoing, this specification discloses a technique for improving reliability of transmission of target data to be transmitted from an external device to a communication device.

According to one aspect, this specification discloses a communication device. The communication device includes a controller and a communication interface configured to connect to a network. The controller is configured to, in a case where the communication device is in an online state, receive, via the communication interface, target data transmitted from an external device by a first communication method. The online state is a state in which the communication device is able to communicate with the external device via the network. The target data is data to be processed by the communication device. The first communication method is a push-type communication method. Thus, the communication device receives the target data from the external device by the first communication method. The controller is configured to, in a case where the communication device transitions from an offline state to the online state, transmit, via the communication interface, a request signal to the external device by a second communication method. The offline state is a state in which the communication device is unable to communicate with the external device via the network. The second communication method is a pull-type communication method. Thus, the communication device transmits the request signal to the external device by the second communication method. The controller is configured to receive, via the communication interface, the target data from the external device as a response to the request signal by the second communication method. Thus, the communication device receives the target data from the external device by the second communication method. The controller is configured to determine whether there is unreceived target data in the external device. The unreceived target data is the target data that has not been received by the communication device. Thus, the communication device determines whether there is unreceived target data in the external device. The controller is configured to, until determining that there is no unreceived target data in the external device, repeat transmitting the request signal to the external device by the second communication method. Thus, the communication device repeats transmitting the request signal to the external device by the second communication method until all the target data stored in the external device are received.

When the communication device is in the offline state, even if the external device transmits the target data in the push-type communication, the communication device may not be able to receive the target data. According to the above configuration, when the communication device transitions from the offline state to the online state, the communication device transmits the request signal in the pull-type communication method and receives the target data from the external device as a response to the request signal. Thus enables the communication device to receive the target data that was not received in the offline state. Further, the communication device determines whether there is unreceived target data in the external device, and repeatedly transmits the request signal to the external device until it is determined that there is no unreceived target data in the external device. Thus, reception omission of the target data is suppressed. This improves the reliability of transmission of the target data to be transmitted from the external device to the communication device.

The technology disclosed in the present specification may be realized in various modes, and may be realized in the form of, for example, a communication device, a communication system including a communication device and an external device, a method of receiving target data, a computer program for realizing the functions of these device, method, and system, a storage medium in which the computer program is recorded, and so on.

### BRIEF DESCRIPTION OF DRAWINGS

FIG. 1 is a block diagram showing a configuration of a system 1000.

FIG. 2 is an explanatory diagram of a management database DBm.

FIG. 3 is an explanatory diagram of an information database IB.

FIG. 4 is a flowchart of processing of an MQTT processing portion MT of a printer 100.

FIG. 5 is a flowchart of processing of a main processing portion CT.

FIG. 6 is a sequence diagram showing an operation example of the system 1000.

FIG. 7 is a sequence diagram showing an operation example of the system 1000.

FIG. 8 is a sequence diagram showing an operation example of the system 1000.

FIG. 9 is a sequence diagram showing an operation example of the system 1000.

FIG. 10 is a flowchart of processing when a command transmission instruction is received.

FIG. 11 is a sequence diagram showing an operation example of the system 1000.

FIG. 12 is a sequence diagram showing an operation example of the of a system.

FIG. 13 is a sequence diagram showing an operation example of the system.

### DESCRIPTION

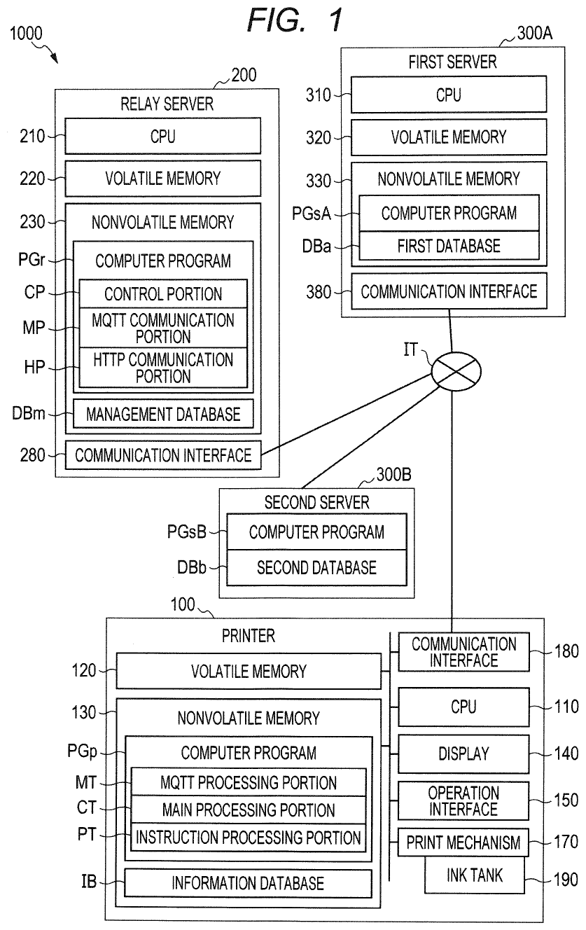

FIG. 1 is a block diagram illustrating a configuration of a system 1000. The system 1000 includes a printer 100, a first server 300A, a second server 300B, and a relay server 200.

The printer 100 is a device that performs printing by consuming ink as a printing material. The printer 100 includes a CPU 110 that controls the printer 100, a volatile memory 120 such as a DRAM, and a nonvolatile memory 130 such as a hard disk or a flash memory. The printer 100 further includes a display 140 such as a liquid crystal display for displaying an image, an operation interface 150 such as a button or a touch panel for acquiring an operation by a user, a print mechanism (print engine) 170, and a communication interface (IF) 180.

The communication interface 180 is an interface for connecting to Internet IT, and is, for example, a wired interface compliant with Ethernet or a wireless interface compliant with the Wi-Fi standard. The “Wi-Fi” is a registered trademark of Wi-Fi Alliance.

The CPU 110 is a computing device (processor) that performs data processing. The volatile memory 120 provides a buffer area for temporarily storing various intermediate data generated when the CPU 110 performs processing. The nonvolatile memory 130 stores a computer program PGp for controlling the printer 100 and an information database IB in which various kinds of information described later are recorded.

In the present embodiment, the computer program PGp is provided by being stored in advance in the nonvolatile memory 130 at the time of manufacturing the printer 100. Instead of this, the computer program PGp may be provided in a form of being downloaded from a server connected via the Internet IT or in a form of being recorded in a storage medium such as a CD-ROM or a USB memory.

The CPU 110 executes various processes for controlling the printer 100 by executing the computer program PGp. For example, the CPU 110 realizes a printing process and a service-related process. The printing process is a process of controlling the print mechanism 170 to cause the print mechanism 170 to print an image. The service-related process is a process for providing, to the user, a first print service and a second print service described later in cooperation with the first server 300A, the second server 300B, and the relay server 200.

For example, by executing the computer program PGp, a CPU 310 functions as an MQTT processing portion MT, a main processing portion CT, and an instruction processing portion PT, which are functional portions for realizing the service-related process.

The MQTT processing portion MT performs communication with the relay server 200 in accordance with a protocol called MQTT (Message Queuing Telemetry Transport). Specifically, in communication according to MQTT, the relay server 200 functions as an MQTT broker, and the printer 100 functions as an MQTT client. In the present embodiment, the MQTT processing portion MT of the printer 100 maintains a communication connection with an MQTT communication portion MP (described later) of the relay server 200, and subscribes to a topic addressed to the printer 100. The connection maintained between the MQTT processing portion MT and the MQTT communication portion MP is, for example, a connection based on the TCP (Transmission Control Protocol)/IP (Internet Protocol). The topic addressed to the printer 100 is, for example, a message (data to be transmitted) having a topic name including a device ID of the printer 100.

The main processing portion CT mainly performs control of the MQTT processing portion MT and the instruction processing portion PT, and communication with the relay server 200 according to the HTTP (Hypertext Transfer Protocol). For example, in communication according to HTTP, the relay server 200 functions as an HTTP server, and the printer 100 functions as an HTTP client.

The instruction processing portion PT executes a process based on a command received from the relay server 200 under the control of the main processing portion CT. Specifically, when the printer 100 receives a print instruction as a command, the instruction processing portion PT executes a print process based on the print instruction.

The information database IB stores setting information of the printer 100 and information necessary for receiving a print service using the printer 100, for example, destination information and authentication information for accessing the first server 300A. The information database IB stores a command list IL as described later.

The print mechanism 170 performs printing in accordance with the control of the CPU 110. The print mechanism 170 of the present embodiment is an inkjet print mechanism that prints an image on a recording medium using a plurality of types of ink (for example, four types of ink of cyan, magenta, yellow, and black) stored in ink tanks 190 as color materials. Alternatively, the print mechanism 170 may be an electrophotographic print mechanism that prints an image on a recording medium using toner contained in a toner cartridge as a color material.

The first server 300A, the second server 300B, and the relay server 200 are, for example, computers operated by a business operator that provides a print service (for example, a business operator that manufactures or sells the printer 100), and are cloud servers, for example.

The first server 300A includes the CPU 310 that controls the first server 300A, a volatile memory 320 such as a DRAM, a nonvolatile memory 330 such as a hard disk or a flash memory, and a communication interface 380. The communication interface 380 is, for example, a wired interface compliant with Ethernet.

The CPU 310 is a computing device (processor) that performs data processing. The volatile memory 320 provides a buffer area for temporarily storing various intermediate data generated when the CPU 310 performs processing. The nonvolatile memory 330 stores a computer program PGsA and a first database DBa.

The computer program PGsA is provided in a form of being uploaded by a business operator who operates the print service, for example. The CPU 310 of the first server 300A executes the computer program PGsA to execute the processing related to the first print service.

In the present embodiment, the first print service provided by the first server 300A is a remote print service. For example, the remote print service is a service of generating a print instruction (also referred to as a print job) using an image file stored in a server by a user or an image file transmitted from a mobile terminal (not shown) of the user, and transmitting the print instruction to the printer, thereby causing the printer to perform printing.

The first database DBa stores various kinds of information necessary for the first print service. For example, the first database DBa includes information (account information and payment information) of a user who uses the first print service and information (a device ID and model information of a printer) of the printer used by the user. Details of the first database DBa are omitted.

Although not shown, the second server 300B includes a CPU 310 that controls the second server 300B, a volatile memory 320, a nonvolatile memory 330, and a communication interface 380, similarly to the first server 300A. However, the nonvolatile memory 330 of the second server 300B stores a computer program PGsB different from the computer program PGsA and a second database DBb different from the first database DBa.

The computer program PGsB is provided in a form of being uploaded by a business operator who operates the print service, for example. The CPU 310 of the second server 300B executes the computer program PGsB to execute processing related to the second print service.

In the present embodiment, the second print service provided by the second server 300B is a printing material management service. The printing material management service is a service for managing the remaining amount of a printing material such as ink in a printer and delivering the printing material to a user in accordance with consumption of the printing material.

The second database DBb stores various kinds of information necessary for the second print service. For example, the second database DBb includes information of a user who uses the second print service (account information and payment information) and information of the printer used by the user (a device ID and model information of a printer). The second database DBb further includes remaining ink amount information and print history information of each printer that are collected from the printer. Details of the second database DBb are omitted.

Although one printer 100 is illustrated in FIG. 1, the first server 300A and the second server 300B provide a print service to a large number of users by using a large number of printers. In the following, various processes for one printer 100 will be described, but these processes are performed independently for each of a plurality of printers (hereinafter, also referred to as target printers) used for a service. For example, the printer 100 is the target printer.

The relay server 200 includes a CPU 210 that controls the relay server 200, a volatile memory 220, a nonvolatile memory 230, and a communication interface 280, similarly to the servers 300A and 300B. The volatile memory 220 provides a buffer area for temporarily storing various intermediate data generated when the CPU 210 performs processing. The nonvolatile memory 230 stores a computer program PGr and a management database DBm.

The communication interface 280 is, for example, a wired interface compliant with Ethernet. Since the communication interface 280 is connected to the Internet IT, the relay server 200 communicates with the servers 300A and 300B via the Internet IT. When the printer 100 is connected to the Internet IT, the relay server 200 communicates with the printer 100 via the Internet IT.

The computer program PGr is provided in a form of being uploaded by a business operator who operates the print service, for example, similarly to the computer programs PGsA and PGsB. The CPU 210 of the relay server 200 executes the computer program PGr to realize the functions as the relay server 200.

Specifically, the relay server 200 (the CPU 210) functions as a control portion CP, an MQTT communication portion MP, and an HTTP communication portion HP by executing the computer program PGr. The control portion CP controls the MQTT communication portion MP and the HTTP communication portion HP to relay communication between the server 300A, 300B and the printer 100.

The MQTT communication portion MP performs communication with the printer 100 in accordance with the above-described MQTT. For example, when the control portion CP publishes the topic addressed to the printer 100 to the MQTT communication portion MP, the MQTT communication portion MP transmits the topic addressed to the printer 100 to the device (that is, the printer 100) that subscribes to the topic.

In this way, in a case where the printer 100 subscribes to the topic addressed to the printer 100, the MQTT communication portion MP transmits data to the printer 100 as a topic at arbitrary timing. Thus, it can be said that the communication method between the relay server 200 and the printer 100 by the MQTT is a push-type communication method.

When the printer 100 is not powered on, for example, the printer 100 cannot subscribe to the topic addressed to the printer 100. In a case where the printer 100 does not subscribe to the topic addressed to the printer 100, even if the control portion CP publishes the topic addressed to the printer 100 to the MQTT communication portion MP, the MQTT communication portion MP does not transmit the topic to the printer 100.

The MQTT communication portion MP does not notify the control portion CP about the transmission result of the topic, regardless of whether the topic is transmitted to the printer 100. Thus, the control portion CP does not know whether the published topic (data to be transmitted) has actually reached the printer 100.

The HTTP communication portion HP performs communication with the printer 100 in accordance with the above-described HTTP. In the present embodiment, when the main processing portion CT of the printer 100 transmits an HTTP request to the relay server 200 (the HTTP communication portion HP), the HTTP communication portion HP transmits, to the printer 100, data to be transmitted as a response (HTTP response) to the HTTP request.

In this way, in response to receiving a request (HTTP request) from the printer 100, the HTTP communication portion HP transmits data to the printer 100 as a response (HTTP response) to the request. Thus, it can be said that the communication method between the relay server 200 and the printer 100 by the HTTP is a pull-type communication method.

In the communication by the HTTP communication portion HP, since data cannot be transmitted to the printer 100 at an arbitrary timing, a delay is likely to occur. In order to reduce the delay, the printer 100 needs to continuously transmit the HTTP request to the relay server 200 at short intervals, and the load on the printer 100 and the relay server 200 is likely to increase. In the communication by the HTTP communication portion HP, since data is transmitted in response to the request of the printer 100, the data is transmitted when the printer 100 is in a state ready to receive data, and thus the data is highly likely to be reliably delivered to the printer 100.

In the present embodiment, as will be described in detail later, the relay server 200 relays communication between the server 300A, 300B and the printer 100 by appropriately using both communication by the MQTT communication portion MP and communication by the HTTP communication portion HP.

For example, the first server 300A transmits, to the printer 100, a print instruction (also referred to as a print job) to be transmitted to the printer 100 via the relay server 200 in order to provide a remote print service. The first server 300A receives information indicating an execution result and so on of the print job from the printer 100 via the relay server 200.

In order to provide a printing material management service, the second server 300B transmits, for example, a transmission instruction of the remaining amount information of a printing material of the printer 100 or a transmission instruction of history information such as a printing history or a failure history of the printer 100, to the printer 100 via the relay server 200. The second server 300B receives information indicating an execution result of the transmission instruction, for example, information indicating the remaining amount of the printing material, and information indicating the printing history and the failure history of the printer 100, from the printer 100 via the relay server 200.

Hereinafter, information (specifically, a print instruction or a transmission instruction) to be transmitted from the servers 300A and 300B to the printer 100 is also referred to as a command. Information to be transmitted from the printer 100 to the servers 300A and 300B, that is, information indicating an execution result of processing executed based on a command (various instructions) is also referred to as execution result information. Specifically, the information indicating the execution result includes a print result, remaining amount information, or history information.

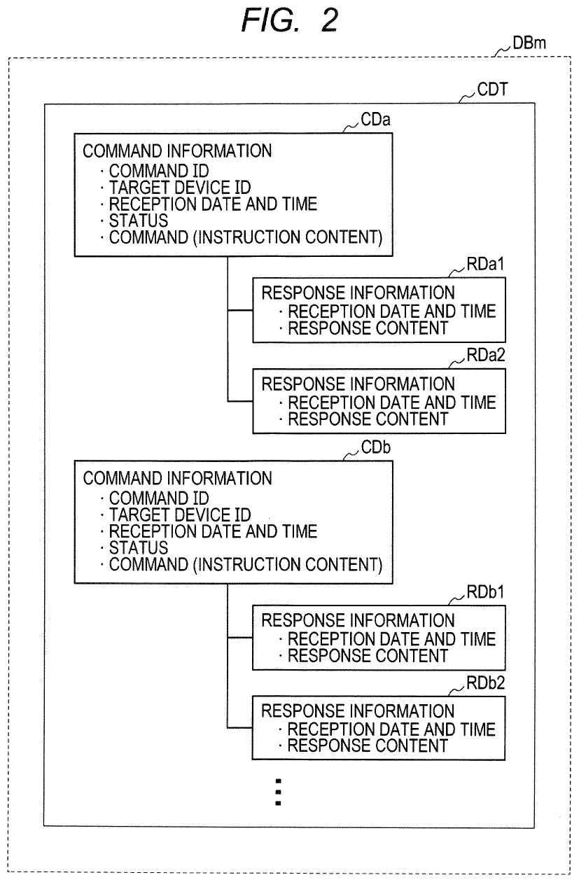

FIG. 2 is an explanatory diagram of the management database DBm. The management database DBm stores a command information table CDT for storing information on commands received from the servers 300A and 300B, that is, information on commands requested to be relayed by the servers 300A and 300B (hereinafter, also referred to as command information). The command information table CDT is prepared for each device of the transmission destination, and FIG. 2 shows the command information table CDT for storing command information relating to commands to be transmitted to the printer 100.

The command information table CDT stores a plurality of command information CDa and CDb. Each command information includes information indicating a command ID, a target device ID, a reception date and time of the command, a status of the command (status information), and the command (the content instructed by the command).

The command ID is an identifier for identifying a command. The target device ID is a device ID of a device (for example, the printer 100) of the transmission destination of the command. The device ID is an identifier for identifying the device. The reception date and time of the command is the date and time when the relay server 200 receives the command from the server 300A, 300B.

In the present embodiment, the status information of the command indicates one of three states, that is, accepted, delivered, and cancelled. The accepted state is a state in which the command has been acquired from the server 300A, 300B but has not been acquired by the device of the transmission destination, and the command has not been canceled by the server 300A, 300B. The delivered state is a state in which the command is acquired by the device of the transmission destination. The cancelled state is a state in which the command is acquired from the server 300A, 300B but is not acquired by the device of the transmission destination, and the command has been cancelled by the server 300A, 300B.

Since a command in the accepted state should be transmitted to the device of the transmission destination, it can be said that the accepted state is a state indicating that the command should be transmitted to the device of the transmission destination. Since the command in the delivered or cancelled state does not need to be transmitted to the device of the transmission destination, it can be said that the delivered or cancelled state is a state indicating that the command does not need to be transmitted to the device of the transmission destination.

Here, a phrase that the command is acquired means that the command is acquired by an application that should process the command in the device of the transmission destination of the command. For example, a phrase that the command is acquired by the relay server 200 means that the command is acquired by the control portion CP which is an application that should process the command in the relay server 200. A phrase that the command is acquired by the printer 100 means that the command is acquired by the main processing portion CT which is an application that should process the command in the printer 100. For example, in a case where the command is received by the communication interface 180 of the printer 100 and is temporarily stored in a reception buffer but the main processing portion CT does not acquire the command from the reception buffer for some reason (for example, an error or a high load), the command is not acquired by the printer 100. Further, in a case where the printer 100 is in the online state and the relay server 200 attempts to transmit a command to the printer 100, but the entire command does not reach the printer 100 due to network congestion and so on, the command is not acquired by the printer 100.

The command is data indicating an instruction content, and includes information necessary for a device (for example, the printer 100) to execute a process based on the command. For example, in a case where the command is a print instruction, the command may include information indicating that the command is a print instruction, information indicating the number of sheets to be printed and print settings, and an image file indicating a print image.

The command information table CDT stores response information transmitted from a device that has received a command, in association with the command information CDa, CDb. In the example of FIG. 2, two response information RDa1 and RDa2 are stored in association with the command information CDa, and two response information RDb1 and RDb2 are stored in association with the command information CDb.

Each response information includes information indicating reception date and time of the response and a response content. The information indicating the reception date and time is the date and time when the relay server 200 receives the response from the device. For example, in a case where the response is an acquisition notification of a command, the response content includes information indicating that the command has been acquired. For example, in a case where the response is a command execution result notification, the response content includes execution result information indicating the result of executing the command.

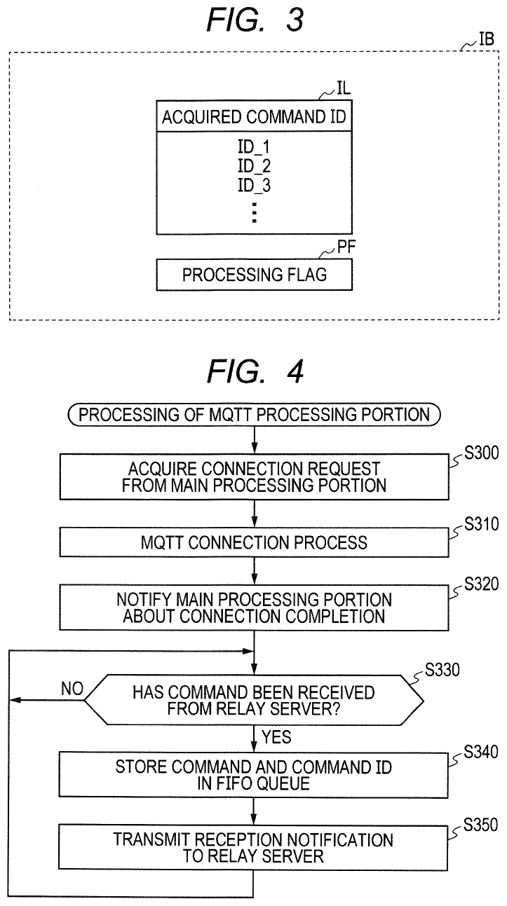

FIG. 3 is an explanatory diagram of the information database IB. The command list IL and a processing flag PF are stored in the information database IB. The command list IL is a list in which command IDs of commands acquired by the printer 100 (also referred to as acquired command IDs) are recorded. The processing flag PF is a flag indicating whether the instruction processing portion PT is performing a process (for example, printing process) based on a command (for example, print instruction). For example, the processing flag PF is set to ON while the instruction processing portion PT is performing a process based on the command, and is set to OFF while the instruction processing portion PT is not performing the process based on the command. The command list IL and the processing flag PF are managed by, for example, the main processing portion CT.

The operation of the system 1000 will be described by focusing on the operation of the printer 100. FIG. 4 is a flowchart of processing by the MQTT processing portion MT of the printer 100. The MQTT processing portion MT operates under the control of the main processing portion CT. Specifically, when a connection request is acquired from the main processing portion CT, the MQTT processing portion MT starts an operation.

In S300 in FIG. 4, the MQTT processing portion MT acquires a connection request from the main processing portion CT. When acquiring the connection request, in S310 the MQTT processing portion MT performs an MQTT connection process. Specifically, the MQTT processing portion MT performs the following processes.

First, the MQTT processing portion MT establishes always-on connection with the MQTT communication portion MP of the relay server 200. The always-on connection is established where the MQTT processing portion MT of the printer 100 serves as an MQTT client, and the MQTT communication portion MP of the relay server 200 serves as an MQTT broker. The always-on connection is maintained while the printer 100 is in the online state. The online state means a state where the printer 100 is connected to the Internet IT, and is able to communicate with the relay server 200. A state where the printer 100 is not in the online state, namely, a state where the printer 100 is not able to communicate with the relay server 200 is referred to as an offline state.

After the always-on connection is established, the MQTT processing portion MT transmits a subscribe request to the MQTT communication portion MP. The subscribe request requests subscription of a topic addressed to the printer 100. The subscribe request includes information indicating a name of the topic (topic name) addressed to the printer 100. In response to receiving the subscribe request, the MQTT communication portion MP of the relay server 200 performs subscribe registration. The subscribe registration is a process for registering the topic having the topic name included in the subscribe request, as a topic to be transmitted to the printer 100. As a result, the printer 100 becomes a state (hereinafter, referred to as a subscribed state) of subscribing the command addressed to the printer 100 (in other words, topic addressed to printer 100). In the subscribed state, the relay server 200 actively (that is, without an individual transmission request from the printer 100) transmits a command to the printer 100 by publishing a command as the topic.

After the MQTT connection process is completed, in S320 the MQTT processing portion MT notifies the main processing portion CT about connection completion. Thereafter, the MQTT processing portion MT becomes a state of waiting for a command transmitted from the relay server 200 by MQTT.

Specifically, in S330, the MQTT processing portion MT determines whether a command has been received from the relay server 200. When no command has been received from the relay server 200 (S330: NO), the MQTT processing portion MT waits until a command is received. When a command has been received from the relay server 200 (S330: YES), in S340 the MQTT processing portion MT stores the command and a command ID received together with the command, in a FIFO (First In First Out) queue (not shown) in the volatile memory 120. The command and the command ID stored in the FIFO queue are sequentially acquired and processed by the main processing portion CT as described later.

In S350, the MQTT processing portion MT transmits a reception notification indicating reception of the command, to the relay server 200. The reception notification is PUBACK defined in the protocol of MQTT. In other words, the reception notification is transmitted as a response to the command according to the protocol of MQTT. After the MQTT processing portion MT transmits the reception notification to the relay server 200, the processing returns to S330, and the MQTT processing portion MT waits until the next command is received.

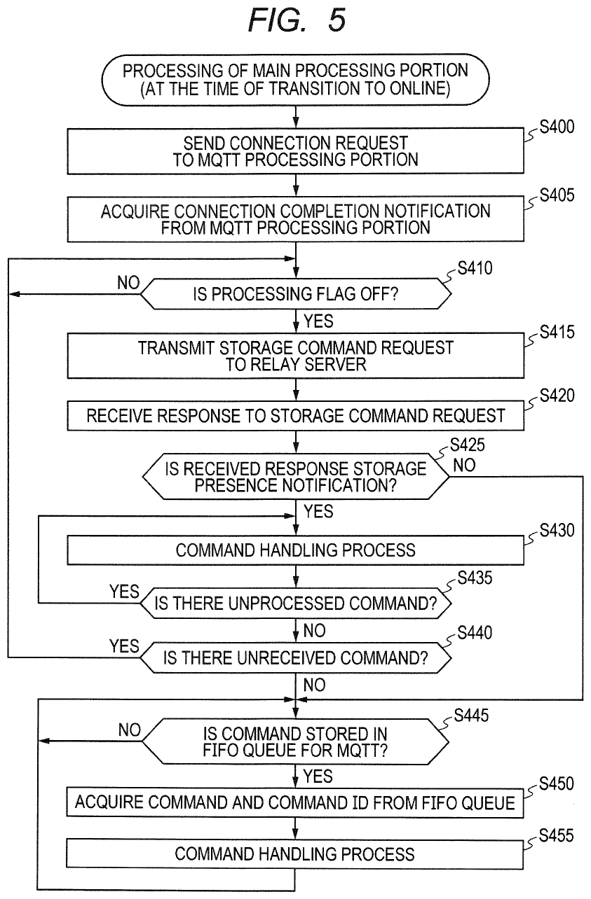

FIG. 5 is a flowchart of processing by the main processing portion CT. The processing is started when the printer 100 transitions from the offline state to the online state. For example, when the printer 100 is turned on, when the printer 100 is connected to a network, or when failure of the network to which the printer 100 is connected is resolved, the printer 100 transitions from the offline state to the online state.

When the printer 100 transitions from the offline state to the online state, in S400 the main processing portion CT sends a connection request to the MQTT processing portion MT. When acquiring the connection request, the MQTT processing portion MT performs the MQTT connection process as described above, and notifies the main processing portion CT about connection completion (S300 to S320 in FIG. 4). In S405, the main processing portion CT acquires a connection completion notification from the MQTT processing portion MT.

When acquiring the connection completion notification, in S410 the main processing portion CT determines whether the processing flag PF (FIG. 3) is OFF. The processing flag PF is ON while the instruction processing portion PT is performing a printing process or another process. Thus, for example, the processing flag PF is normally OFF at power-on.

When the processing flag PF is ON (S410: NO), the main processing portion CT waits until the processing flag PF is turned OFF. When the processing flag PF is OFF (S410: YES), the main processing portion CT advances the processing to S415.

In S415, the main processing portion CT transmits a storage command request to the relay server 200. Information on the relay server 200 (for example, the URL and IP address of the relay server 200) of the transmission destination is preliminarily recorded in the information database IB.

The storage command request is an HTTP request for requiring, when a command to be transmitted to the printer 100 is stored in the relay server 200, transmission of the command. The storage command request includes the device ID of the printer 100 and information indicating an upper limit number of commands N. The upper limit number of commands Nis the number (maximum number) of commands receivable by the printer 100 in one response (HTTP response).

In response to receiving the storage command request, the relay server 200 checks whether the command to be transmitted to the printer 100 is stored in the relay server 200. Specifically, the relay server 200 determines whether command information including information indicating that the status of the command is an accepted state (hereinafter, also referred to as command information in accepted state) is stored in the command information table CDT (FIG. 2) for storing command information relating to the command to be transmitted. When the command information in the accepted state is stored in the command information table CDT, the control portion CP determines that a command to be transmitted is stored. When no command information in the accepted state is stored in the command information table CDT, the relay server 200 determines that no command to be transmitted is stored.

When the relay server 200 determines that a command to be transmitted is stored, the relay server 200 transmits a storage presence notification indicating that a command to be transmitted is stored, to the printer 100 as a response to the storage command request. The storage presence notification includes one or more commands to be transmitted to the printer 100, and information indicating a number of storage commands (stored commands) M. The number of storage commands M indicates the number of commands to be transmitted to the printer 100 among the commands stored in the command information table CDT, namely, the number of commands associated with the status information indicating the accepted state.

When it is determined that no command to be transmitted to the printer 100 is stored, the relay server 200 transmits a storage absence notification indicating that no command to be transmitted is stored, to the printer 100 as the response to the storage command request.

In S420, the main processing portion CT of the printer 100 receives the response to the storage command request from the relay server 200. The response is any of the storage presence notification and the storage absence notification as described above. In S425, the main processing portion CT determines whether the received response is the storage presence notification or the storage absence notification. When the received response is the storage presence notification (S425: YES), the main processing portion CT advances the processing to S430. When the received response is the storage absence notification (S425: NO), the main processing portion CT advances the processing to S445.

In S430, the main processing portion CT performs a command handling process for one command included in the storage presence notification. The command handling process is a process performed by the main processing portion CT for each command received by the printer 100. The command handling process includes, for example, a process of passing the command to the instruction processing portion PT and causing the instruction processing portion PT to perform a process (for example, a printing process) based on the command. The command handling process includes, for example, a process of receiving a notification (acquisition notification or execution result notification) relating to the process based on the command, from the instruction processing portion PT, and transmitting the notification as an HTTP request to the relay server 200. Details of the command handling process are described later with reference to sequence diagrams.

When the command handling process for one command is finished, in S435 the main processing portion CT determines whether there is an unprocessed command. In other words, the main processing portion CT determines whether there is a command that is included in the received storage presence notification and for which the command handling process has not been performed. As described above, the received storage presence notification may include a plurality of commands.

When there is an unprocessed command (S435: YES), the main processing portion CT returns the processing to S430, and performs the command handling process for the unprocessed command. When there is no unprocessed command (S435: NO), the main processing portion CT advances the processing to S440.

In S440, the main processing portion CT determines whether there is an unreceived command. The storage presence notification includes the information indicating the number of storage commands M as described above. When the number of storage commands M is greater than the upper limit number of commands N, the printer 100 cannot receive all commands stored in the relay server 200 in one response. In this case, it is necessary for the printer 100 to receive the M commands in two or more responses. When the number of received commands is less than the number of storage commands M, the main processing portion CT determines that there is an unreceived command. When the number of received commands matches the number of storage commands M, the main processing portion CT determines that there is no unreceived command.

When there is an unreceived command (S440: YES), the main processing portion CT returns the processing to S410. When there is no unreceived command (S440: NO), the main processing portion CT advances the processing to S445.

At the time point when the processing proceeds to S445, the commands to be received by the printer 100 by using the HTTP from the relay server 200 have been all received and processed. Thus, the main processing portion CT transitions to a state of processing a command received by the MQTT processing portion MT. Specifically, in S445, the main processing portion CT monitors whether a command is stored in the above-described FIFO queue for the MQTT. When no command is stored in the FIFO queue (S445: NO), the MQTT processing portion MT waits until a command is stored in the FIFO queue, namely, until the MQTT processing portion MT newly receives a command.

When a command is stored in the FIFO queue (S445: YES), in S450 the main processing portion CT sequentially acquires a set of a command and a command ID one set at a time from the FIFO queue. In S455, the main processing portion CT performs the command handling process for the command acquired from the FIFO queue. When the main processing portion CT performs the command handling process for one command, the processing returns to S445.

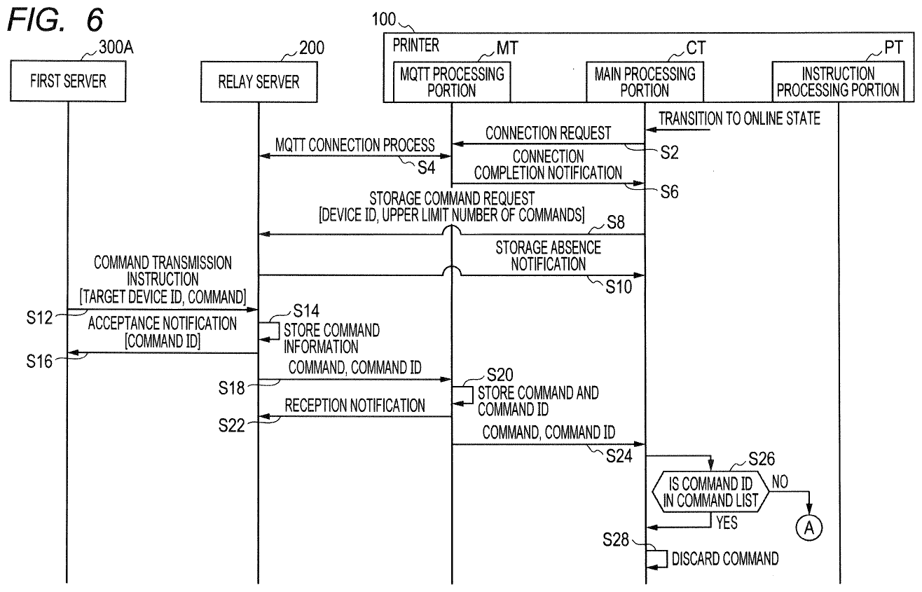

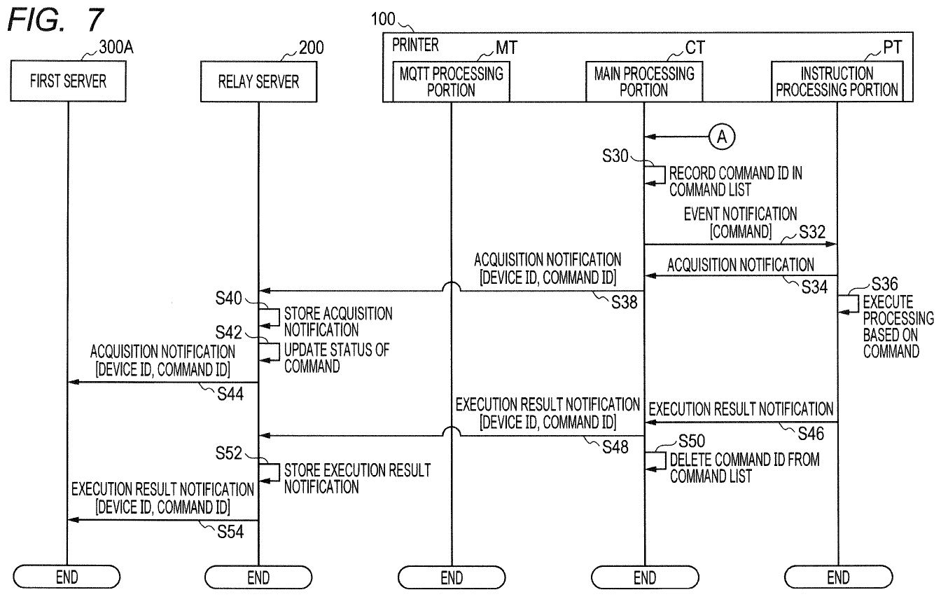

Next, an example of operation realized when the MQTT processing portion MT and the main processing portion CT perform the above-described processing shown in FIG. 4 and FIG. 5 is described. FIG. 6 to FIG. 9 are sequence diagrams illustrating an operation example of the system 1000 according to the embodiment. FIG. 6 and FIG. 7 illustrate the operation example when the printer 100 is in the subscribed state at the time when a command is accepted by the relay server 200. The time when a command is accepted by the relay server 200 means a time point when the first server 300A transmits a command transmission instruction to the relay server 200, and the relay server 200 acquires the command transmission instruction.

To facilitate understanding, a time point when the printer 100 transitions from the offline state to the online state is first described. When the printer 100 transitions from the offline state to the online state, in S2 in FIG. 6, the main processing portion CT of the printer 100 transmits the connection request to the MQTT processing portion MT (S400 in FIG. 5).

When acquiring the connection request (S300 in FIG. 4), in S4 the MQTT processing portion MT of the printer 100 performs the MQTT connection process (S310 in FIG. 4). As a result, the printer 100 becomes the subscribed state. In S6, the MQTT processing portion MT transmits the connection completion notification to the main processing portion CT (S320 in FIG. 4). As a result, the main processing portion CT acquires the connection completion notification (S405 in FIG. 5). In S8, the main processing portion CT transmits the storage command request to the relay server 200 (S415 in FIG. 5).

In response to receiving the storage command request, the relay server 200 checks whether a command to be transmitted to the printer 100 is stored in the relay server 200 as described above. In the example shown in FIG. 6, it is assumed that no command to be transmitted is stored in the relay server 200. Thus, in S10, the relay server 200 transmits the storage absence notification as the response to the storage command request, to the printer 100.

In response to receiving the storage absence notification, the main processing portion CT of the printer 100 transitions to the state of processing the command received by the MQTT processing portion MT as described above. In other words, the main processing portion CT becomes the state of monitoring the FIFO queue for the MQTT described above (S445 in FIG. 5).

In this way, it is assumed that, after the printer 100 becomes the subscribed state, the first server 300A transmits a command transmission instruction to the relay server 200 (S12 in FIG. 6). The command transmission instruction instructs the relay server 200 to transmit a command to the device. The command transmission instruction includes the target device ID and the command of the transmission target. The target device ID is an identifier indicating the device to which the command is to be transmitted. The communication between the first server 300A and the relay server 200 is performed in accordance with a known communication protocol (for example, HTTP or a dedicated protocol).

When the relay server 200 receives the command transmission instruction, in S14 the relay server 200 stores command information (FIG. 2) regarding the command included in the command transmission instruction. Specifically, the relay server 200 (the control portion CP) generates a command ID to be assigned to the command included in the command transmission instruction. The relay server 200 generates information indicating the current date and time as information indicating the reception date and time of the command. The relay server 200 generates information indicating “accepted” as status information indicating the current status of the command. The relay server 200 stores command information in the command information table CDT (FIG. 2) of the management database DBm. The command information includes the command and the target device ID included in the command transmission instruction and the generated information (the command ID, the reception date and time, and the status). In the example of FIG. 6, it is assumed that the first command information CDa is stored in the command information table CDT of FIG. 2 at this point.

Here, the information indicating the reception date and time of the command can also be referred to as information indicating storage date and time when the command information is stored in the command information table CDT. By comparing the information indicating the reception date and time of the command, in a case where a plurality of command information are stored in the command information table CDT, the storage order of the plurality of command information is identified. Thus, the information indicating the reception date and time of the command can also be referred to as information for identifying the storage order of the plurality of command information or information indicating the acceptance order of the transmission instruction of the plurality of commands.

In S16, the relay server 200 transmits, to the first server 300A, an acceptance notification indicating that the command transmission instruction has been accepted. The acceptance notification includes the command ID included in the command information stored in S14 and status information of the command.

In S18, the relay server 200 transmits the command and the command ID to the printer 100. Specifically, for example, the control portion CP sends a publish request to the MQTT communication portion MP. The publish request requests transmitting the designated data to a device subscribing to the designated topic. The publish request includes a topic name for designating the topic and data to be transmitted. In the example of FIG. 6, the topic name included in the publish request is the name of the topic addressed to the printer 100. The data included in the publish request includes the command included in the command transmission instruction and the command ID of the command.

In response to receiving the publish request, the MQTT communication portion MP attempts to transmit the command and the command ID included in the publish request to devices that subscribe to the topic designated by the topic name included in the publish request. At this point in time, the printer 100 is in the subscribed state, and the MQTT communication portion MP stores information that the printer 100 subscribes to the topic addressed to the printer 100. Thus, in S18, by the MQTT communication portion MP, the command and the command ID are transmitted from the relay server 200 to the printer 100.

In S18, the MQTT processing portion MT of the printer 100 receives the command and the command ID. In response to receiving the command and the command ID, in S20 the MQTT processing portion MT stores the command and the command ID in the FIFO queue (S330 and S340 in FIG. 4). In S22, the MQTT processing portion MT transmits the reception notification indicating reception of the command, to the relay server 200 (S350 in FIG. 4).

At this time point, the main processing portion CT has transitioned to an MQTT acceptance mode. Thus, the main processing portion CT monitors the FIFO queue in which the command received by the MQTT processing portion MT is stored (S445 in FIG. 5). In S24, the main processing portion CT acquires the command and the command ID stored in the FIFO queue in S20, from the FIFO queue (S450 in FIG. 5).

When acquiring the command and the command ID from the FIFO queue, the main processing portion CT performs the above-described command handling process for the command (S455 in FIG. 5). The command handling process is a series of processes for one command performed by the main processing portion CT, the instruction processing portion PT, the MQTT processing portion MT, the relay server 200, and the first server 300A in cooperation with one another. The processing in S26 in FIGS. 6 to S54 in FIG. 7 correspond to the command handling process for one command. Specific description is given below.

In S26, the main processing portion CT determines whether the acquired command ID is included in the command list IL. In other words, the main processing portion CT compares the acquired command ID with the command IDs recorded in the command list IL. The main processing portion CT determines from the comparison whether the acquired command ID matches one of the command IDs recorded in the command list IL. When the acquired command ID is included in the command list IL (S26: YES), in S28 the main processing portion CT discards the command without performing a process (for example, a printing process) based on the command. When the command ID is included in the command list IL, it is considered that the process based on the command has been already performed. Thus, the command is discarded in order to prevent repetitive execution of the process.

When the command ID is not included in the command list IL (S26: NO), in S30 the main processing portion CT records the command ID in the command list IL. In S32, the main processing portion CT sends an event notification including the acquired command, to the instruction processing portion PT. In response to receiving the event notification including the command, in S34 the instruction processing portion PT transmits an acquisition notification to the main processing portion CT. The acquisition notification includes information indicating that the command has been acquired, as the information indicating the status of the command.

In response to receiving the acquisition notification from the instruction processing portion PT, in S38 the main processing portion CT transmits the acquisition notification to the relay server 200. The acquisition notification includes the command ID of the command transmitted to the instruction processing portion PT, and the device ID of the printer 100. The acquisition notification is transmitted as an HTTP request to the relay server 200. Thus, the acquisition notification is received by the HTTP communication portion HP (FIG. 1) of the relay server 200.

When the relay server 200 receives the acquisition notification, at this point, the relay server 200 (the control portion CP) recognizes that the command has been acquired by the printer 100.

In response to receiving the acquisition notification, the relay server 200 stores the acquisition notification in S40. Specifically, the control portion CP of the relay server 200 generates information indicating a current date and time as information indicating a reception date and time of the acquisition notification. The control portion CP generates response information including the acquisition notification and the information on the reception date and time of the acquisition notification. The control portion CP identifies the command of the processing target (the command to be processed), by referring to the command ID included in the acquisition notification. The control portion CP stores the response information in the command information table CDT (FIG. 2) of the management database DBm in association with the command information of the command of the processing target. For example, it is assumed that the command information of the command of the processing target is the command information CDa shown in FIG. 2. In this step, the first response information RDa1 is stored in the command information table CDT in association with the command information CDa.

In S42, the relay server 200 updates the status information of the command of the processing target, from an accepted state to a delivered state. For example, the control portion CP of the relay server 200 changes the status information included in the command information CDa in the command information table CDT shown in FIG. 2, from the information indicating the accepted state to the information indicating the delivered state. As described above, the control portion CP updates the status information of the command of the processing target, from the accepted state to the delivered state when the first response for the command of the processing target is received. The control portion CP may receive a second response (for example, execution result notification described later) for the command of the processing target. When the control portion CP receives the second or subsequent response, the control portion CP does not update the status information.

In S44, the relay server 200 transmits the acquisition notification received in S38, to the first server 300A. As a result, the first server 300A recognizes that the command has been transmitted to the printer 100 based on the command transmission instruction transmitted in S12, and acquired by the printer 100.

After transmitting the acquisition notification in S34, in 36 the instruction processing portion PT of the printer 100 performs a process based on the command received in S32 in FIG. 7. For example, when the command is a print instruction, the printer 100 performs a printing process using an image file designated by the command.

In S46, the instruction processing portion PT sends an execution result notification to the main processing portion CT. The execution result notification includes, as the information indicating the status of the command, information indicating execution completion of the process based on the command and information indicating an execution result. In S48, the main processing portion CT transmits the received execution result notification to the relay server 200. The execution result notification includes the command ID of the executed command, and the device ID of the printer 100 as with the above-described acquisition notification. The execution result notification is transmitted as an HTTP request to the relay server 200, as with the acquisition notification. Thus, the execution result notification is received by the HTTP communication portion HP of the relay server 200.

In S50, the main processing portion CT deletes the command ID of the processed command, from the command list IL.

In response to receiving the execution result notification, in S52 the relay server 200 stores the execution result notification. Specifically, the control portion CP of the relay server 200 generates information indicating a current date and time as information indicating a reception date and time of the execution result notification. The control portion CP generates response information including the execution result notification and the information on the reception date and time of the execution result notification. The control portion CP identifies the command of the processing target, by referring to the command ID included in the execution result notification. The control portion CP stores the response information in the command information table CDT (FIG. 2) of the management database DBm in association with the command information of the command of the processing target. For example, it is assumed that the command information of the command of the processing target is the command information CDa shown in FIG. 2. In this step, the second response information RDa2 is stored in the command information table CDT in association with the command information CDa.

In S54, the relay server 200 transmits the execution result notification received in S48, to the first server 300A. As a result, the first server 300A recognizes that execution of the process based on the command transmitted based on the command transmission instruction transmitted in S12 is completed. For example, the first server 300A recognizes that the printing process by the printer 100 has been performed based on the print instruction transmitted as the command.

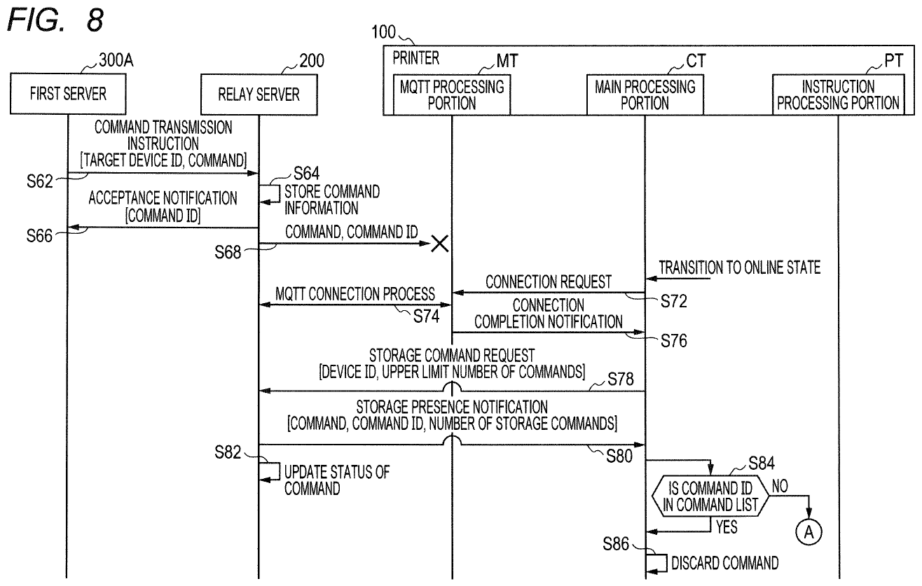

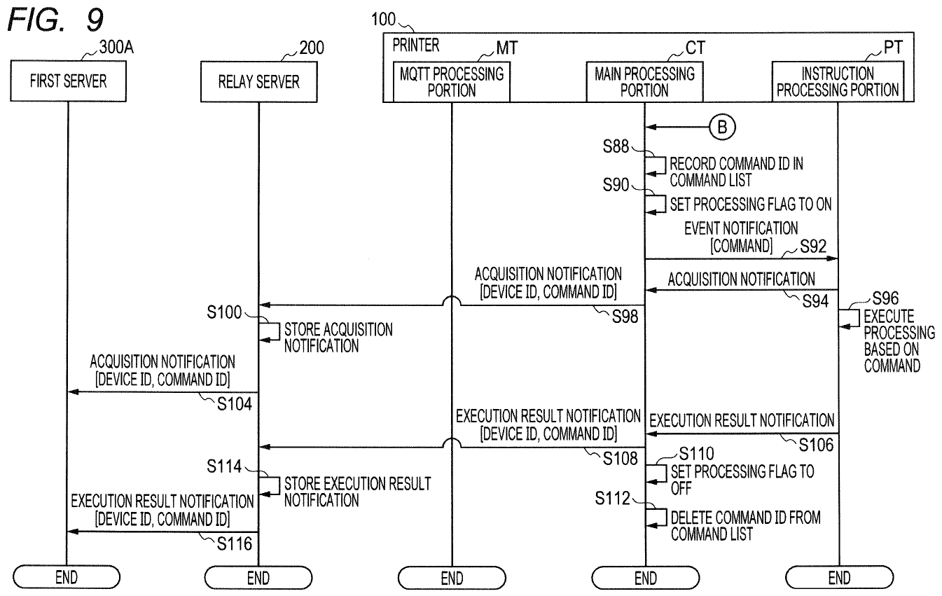

FIG. 8 and FIG. 9 illustrate the operation example when the printer 100 does not subscribe a command at the time when the relay server 200 accepts a command. For example, it is assumed that the printer 100 is in the offline state because the printer 100 is turned off, and the printer 100 does not subscribe to the command. In this state, in S62 in FIG. 8, the first server 300A transmits a command transmission instruction to the relay server 200. The command transmission instruction is transmitted in a manner similar to S12 in FIG. 6.

In response to receiving the command transmission instruction, the relay server 200 stores the command information (FIG. 2) on the command included in the command transmission instruction in S64, in a manner similar to S14 in FIG. 6.

In S66, the relay server 200 transmits an acceptance notification indicating that the command transmission instruction has been accepted, to the first server 300A in a manner similar to S16 in FIG. 6.

In S68, the relay server 200 attempts to transmit the command and the command ID to the printer 100 in a manner similar to S18 in FIG. 6. Specifically, the control portion CP of the relay server 200 passes a publish request to the MQTT communication portion MP of the relay server 200. In response to receiving the publish request, the MQTT communication portion MP attempts to transmit the command and the command ID included in the publish request, to the device that subscribes a topic designated by a topic name included in the publish request.

At this time, unlike the example shown in FIG. 6, the printer 100 is not in the subscribed state. Thus, information that the printer 100 subscribes to the topic addressed to the printer 100 is not registered (stored) in the MQTT communication portion MP. Thus, the MQTT communication portion MP does not transmit the command and the command ID to the printer 100. The MQTT communication portion MP does not notify the control portion CP that the command is not transmitted to the printer 100 due to the specification of MQTT. Thus, the control portion CP does not recognize that the command has not been acquired by the printer 100.

Thereafter, it is assumed that the printer 100 transitions from the offline state to the online state due to power-on of the printer 100, for example. When the printer 100 transitions to the online state, in S72 the main processing portion CT of the printer 100 sends a connection request to the MQTT processing portion MT (S400 in FIG. 5) in a manner similar to S2 in FIG. 6.

In response to acquiring the connection request (S300 in FIG. 4), in S74 the MQTT processing portion MT of the printer 100 performs MQTT connection process (S310 in FIG. 4) in a manner similar to S4 in FIG. 6. As a result, the printer 100 becomes the subscribed state. In S76, the MQTT processing portion MT sends a connection completion notification to the main processing portion CT (S320 in FIG. 4) in a manner similar to S6 in FIG. 6. As a result, the main processing portion CT acquires the connection completion notification (S405 in FIG. 5). In S78, the main processing portion CT transmits a storage command request to the relay server 200 (S415 in FIG. 5) in a manner similar to S8 in FIG. 6.

In response to receiving the storage command request, the relay server 200 checks whether a command to be transmitted to the printer 100 is stored in the relay server 200 as described above. In the example shown in FIG. 8, at this time point, the command to be transmitted to the printer 100 based on the command transmission instruction received in S62 has not been transmitted to the printer 100. Thus, the status of the command is the accepted state and is not the delivered state. Thus, the command information of that command is stored in the command information table CDT, and the command information indicates the accepted state.

Thus, in the example shown in FIG. 8, at this time point, the control portion CP determines that a command to be transmitted to the printer 100 is stored in the relay server 200. Thus, in S80, the relay server 200 transmits a storage presence notification indicating that a command to be transmitted is stored, as the response to the storage command request, to the printer 100. The storage presence notification is transmitted as the HTTP response as with the storage absence notification.

The storage presence notification includes the command to be transmitted to the printer 100, and information indicating the number of storage commands. In the example shown in FIG. 8, one command information in the accepted state is stored in the command information table CDT, and thus, the number of storage commands is one. The number of storage commands indicates the number of commands to be transmitted to the printer 100 among the commands stored in the command information table CDT, namely, the number of commands associated with the status information indicating the accepted state.

Upon transmitting the storage presence notification to the printer 100, in S82 the relay server 200 updates the status information of the command of the processing target, from the accepted state to the delivered state. As described above, in S82, the relay server 200 immediately updates the status information at the time point when the storage presence notification including the command is transmitted as the HTTP response, without receiving the acquisition notification from the printer 100.

In response to receiving the storage presence notification, the printer 100 receives one command in the example shown in FIG. 8. In other words, the main processing portion CT of the printer 100 acquires the command by using a communication according to HTTP. As described above, in response to receiving the storage presence notification (S420, and YES in S425 in FIG. 5), the main processing portion CT of the printer 100 performs the command handling process for the command included in the storage presence notification (S430 in FIG. 5).

The command handling process for the command acquired through communication according to HTTP is processes in S84 in FIGS. 8 to S116 in FIG. 9, and is a series of processes performed by the main processing portion CT, the instruction processing portion PT, the relay server 200, and the first server 300A in cooperation with one another. The command handling process for the command acquired through communication according to HTTP is substantially similar to the command handling process (S26 in FIGS. 6 to S54 in FIG. 7) for the command acquired through communication according to MQTT described above. However, control of the processing flag PF and so on are different between the two command handling processes. Specific description is given below.

In S84, the main processing portion CT determines whether the acquired command ID is included in the command list IL. When the acquired command ID is included in the command list IL (S84: YES), in S86 the main processing portion CT discards the command without performing the process based on the command.

When the command ID is not included in the command list IL (S84: NO), in S88 the main processing portion CT records the command ID in the command list IL. In S90, the main processing portion CT sets the processing flag PT to ON. In S92, the main processing portion CT sends an event notification including the acquired command, to the instruction processing portion PT. In response to receiving the event notification including the command, in S94 the instruction processing portion PT sends an acquisition notification indicating that the command has been acquired, to the main processing portion CT.

In response to receiving the acquisition notification from the instruction processing portion PT, in S98 the main processing portion CT transmits the acquisition notification to the relay server 200. The acquisition notification includes the command ID of the command transmitted to the instruction processing portion PT, and the device ID of the printer 100. The acquisition notification is transmitted as an HTTP request to the relay server 200.

In response to receiving the acquisition notification, the relay server 200 stores the acquisition notification in S100. Specifically, in a manner similar to S40 in FIG. 7, the control portion CP of the relay server 200 generates response information including the acquisition notification and information on a reception date and time, and stores the response information in the command information table CDT (FIG. 2) of the management database DBm in association with the command information of the command of the processing target.

In the command handling process for the command acquired through the notification according to HTTP, it is unnecessary to update the status information of the command of the processing target at this time point. This is because the status information of the command has been already updated in S82 immediately after the storage presence notification including the command is transmitted to the printer 100 in S80 in FIG. 8.

In S104, the relay server 200 transmits the acquisition notification received in S98, to the first server 300A. As a result, the first server 300A recognizes that the command has been transmitted to the printer 100 based on the command transmission instruction transmitted in S62, and acquired by the printer 100.

After transmitting the acquisition notification in S94, in S96 in FIG. 6 the instruction processing portion PT of the printer 100 performs a process based on the received command. In S106, the instruction processing portion PT sends an execution result notification indicating an execution result of the process based on the command, to the main processing portion CT. In S108, the main processing portion CT transmits the received execution result notification to the relay server 200. As with the above-described acquisition notification, the execution result notification includes the command ID of the processed command, and the device ID of the printer 100. The execution result notification is transmitted as an HTTP request to the relay server 200, as with the acquisition notification.

The main processing portion CT recognizes from the execution result notification that the instruction processing portion PT has completed the process based on the command. Thus, in S110, the main processing portion CT sets the processing flag PF to OFF. In S112, the main processing portion CT deletes the command ID of the processed command from the command list IL.

In response to receiving the execution result notification, the relay server 200 stores the execution result notification in S114. Specifically, the control portion CP of the relay server 200 generates response information including the execution result notification and information on a reception date and time, and stores the response information in the command information table CDT (FIG. 2) of the management database DBm, in association with the command information of the command of the processing target.

In S116, the relay server 200 transmits the execution result notification received in S108, to the first server 300A. As a result, the first server 300A recognizes the execution result of the process based on the command transmitted based on the command transmission instruction transmitted in S62.

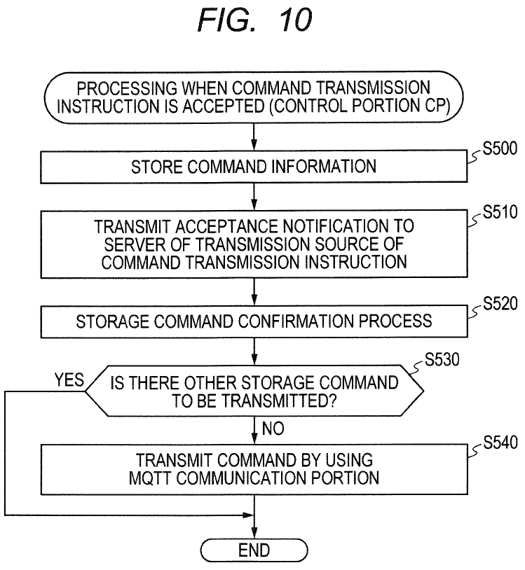

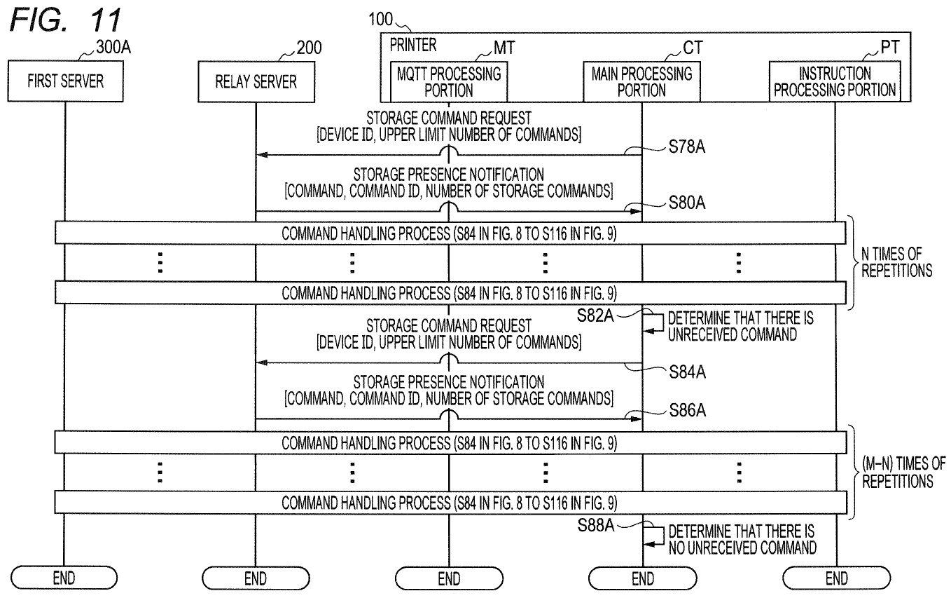

The operation of the system 1000 is described above. With reference to FIG. 10, processing when the control portion CP of the relay server 200 receives a command transmission instruction from the server 300A or 300B (S12 in FIG. 6, or S62 in FIG. 8) is supplementarily described. FIG. 10 is a flowchart of processing when the command transmission instruction is accepted.

For example, as shown in S12 in FIGS. 6 and S62 of FIG. 8, when the relay server 200 receives the command transmission instruction from the server 300A or 300B, in S500 the control portion CP of the relay server 200 stores the command information in the command information table CDT. In S510, the control portion CP transmits an acceptance notification to the server (for example, first server 300A) which is the transmission source of the command transmission instruction. The processing in S500 corresponds to the processing in S14 in FIGS. 6 and S64 in FIG. 8, and the processing in S510 corresponds to the processing in S16 in FIGS. 6 and S66 in FIG. 8.

In S520, the control portion CP performs a storage command confirmation process. The storage command confirmation process is a process of confirming (checking) whether a command to be transmitted to the printer 100 is stored in the relay server 200. Specifically, as in the case where the storage command request is received, the control portion CP of the relay server 200 determines whether the command information indicating that the status of the command is the accepted state (hereinafter, also referred to as command information in the accepted state) is stored in the command information table CDT (FIG. 2). When the command information indicating the accepted state is stored in the command information table CDT, the control portion CP determines that a command to be transmitted is stored. When the command information indicating the accepted state is not stored in the command information table CDT, the relay server 200 determines that no command to be transmitted is stored.

In S530, when the control portion CP determines in the storage command confirmation process that no other command to be transmitted is stored (S530: NO), in S540 the control portion CP transmits a command (also referred to as target command) based on the received command transmission instruction, to the printer 100 by using the MQTT communication portion MP. The processing in S540 corresponds to the processing in S18 in FIGS. 6 and S68 in FIG. 8.

When the control portion CP determines in the storage command confirmation process that another command to be transmitted is stored (S530: YES), the processing in S540 is skipped. In other words, when it is determined that another command to be transmitted is stored (S530: YES), the control portion CP does not transmit the target command by using the MQTT communication portion MP.

As described above, in a case where no other command to be transmitted to the printer 100 is stored, when the printer 100 is in the subscribed state, as shown in S18 of FIG. 6, the target command is immediately transmitted from the MQTT communication portion MP to the printer 100. In contrast, in a case where another command to be transmitted to the printer 100 is stored, even when the printer 100 is in the subscribed state, the target command is not transmitted from the MQTT communication portion MP to the printer 100.

The reason for this will be explained. It is assumed that the target command is immediately transmitted from the MQTT communication portion MP to the printer 100 even though another command to be transmitted to the printer 100 is stored. In this case, the target command is transmitted to the printer 100 even though the other command to be transmitted has not been transmitted to the printer 100. In this case, the reception of the transmission instruction of the other command is performed before the target command, but the transmission of the other command to the printer 100 is performed after the target command. That is, the order of transmitting commands is different from the order of accepting the transmission instruction of the commands. In this case, if the execution order of the commands in the printer 100 is meaningful, the printer 100 may not be able to perform a desired operation. For example, when a user wants to print page 2 after page 1, a problem may occur in which page 2 is printed before page 1.

In the present embodiment, in order to suppress such an inconvenience, in a case where another command to be transmitted is stored, the target command is not transmitted from the MQTT communication portion MP, and thus the target command is stored together with the other command. The other command and the target command that have been stored are both transmitted to the printer 100 by using the HTTP communication portion HP. As will be described later, in a case where a plurality of commands are stored, the HTTP communication portion HP transmits the commands to the printer 100 in accordance with the order of acceptance of the transmission instruction of the commands, and thus the above-described inconvenience is suppressed.

In FIG. 6, the case has been described in which no command to be transmitted is stored in the relay server 200 when the storage command request is transmitted from the printer 100 to the relay server 200 (S8 in FIG. 6). In FIG. 8 and FIG. 9, the case has been described in which one command to be transmitted is stored in the relay server 200 when the storage command request is transmitted from the printer 100 to the relay server 200 (S78 in FIG. 8).

A case will be described in which M commands to be transmitted are stored in the relay server 200 when the storage command request is transmitted from the printer 100 to the relay server 200 (S78A in FIG. 11), with reference to FIG. 11. In this case, the control portion CP of the relay server 200 determines in the storage command confirmation process (S520 in FIG. 10) that a plurality of commands to be transmitted are stored. The number of storage commands is M. When the upper limit number of commands described above is N (N is integer of 1 or more), M is greater than N and is less than two times of N (N<M<2N). The number of commands included in one storage presence notification is limited to N or less.

In S80A in FIG. 11, in response to receiving the storage command request, the relay server 200 (control portion CP) transmits the storage presence notification as a response to the storage command request to the printer 100 by using the HTTP communication portion HP. Specifically, the control portion CP identifies an acceptance order of the M commands, namely, a storage order of M command information in the command information table CDT, based on the reception date and time of each of the M commands to be transmitted. The control portion CP identifies N commands based on the storage order of the M commands. The control portion CP generates a storage presence notification including the N commands. In the storage presence notification, the N commands are arranged in the storage order. As a result, when the storage presence notification is transmitted from the relay server 200 to the printer 100, the N commands are sequentially transmitted to the printer 100 in the storage order. The storage presence notification further includes information indicating the number of storage commands M.

The main processing portion CT of the printer 100 acquires the N commands in the storage order of the commands by receiving the storage presence notification. In response to acquiring the N commands, the main processing portion CT performs the above-described command handling process for each of the N commands (S430 and S435 in FIG. 5). As described above, the command handling process is the processing in S84 in FIGS. 8 to S116 in FIG. 9. In other words, the command handling process in S84 in FIGS. 8 to S116 in FIG. 9 is repeatedly performed N times. The command handling process for each of the commands is performed in the storage order of the commands.

Since the storage presence notification received by the printer 100 includes the information indicating the number of storage commands M, the main processing portion CT of the printer 100 recognizes that there are (M-N) unacquired commands in the relay server 200 in addition to the N acquired commands. Thus, after the command handling process is repeated N times, in S82A the main processing portion CT determines that there is unreceived command (YES in S440 in FIG. 5). Thus, in S84A in FIG. 11, the main processing portion CT transmits the storage command request to the relay server 200 again in order to acquire the (M-N) unacquired commands.

In response to receiving the storage command request, in S86A the relay server 200 transmits the storage presence notification as a response to the storage command request, to the printer 100. Specifically, since the remaining (M-N) commands to be transmitted are stored in the relay server 200, the control portion CP of the relay server 200 generates a storage presence notification including the remaining (M-N) commands, and transmits the storage presence notification to the printer 100 by using the HTTP communication portion HP. In the storage presence notification, the (M-N) commands are arranged in the storage order.

The main processing portion CT of the printer 100 acquires the remaining (M-N) commands in the storage order of the commands by receiving the storage presence notification. The main processing portion CT performs the above-descried command handling process for each of the (M-N) commands (S430 and S435 in FIG. 5). In other words, the command handling process is repeatedly performed (M-N) times. The command handling process for each of the commands is performed in the storage order of the commands.

Since the storage presence notification received by the printer 100 includes the information indicating the number of storage commands (M-N), the main processing portion CT of the printer 100 recognizes that there is no unacquired command in the relay server 200. Thus, after the command handling process is repeated (M-N) times, the main processing portion CT determines that there is no unreceived command in S88A (NO in S440 in FIG. 5). As can be seen from the above description, it is determined that there is an unacquired command in the relay server 200 based on the information indicating the number of storage commands. Thus, it can be said that the information indicating the number of storage commands is information at least indicating presence or absence of the unreceived command.

According to the above-described embodiment, the printer 100 realizes the push-type communication method by the communication according to MQTT, and receives the data that is transmitted actively from the relay server 200 (S300 to S350 in FIG. 4). The printer 100 realizes the pull-type communication method by the communication according to HTTP, transmits the storage command request to the relay server 200, and receives the data from the relay server 200 as the response to the storage command request (S415 and S420 in FIG. 5). When the printer 100 is in the online state, the printer 100 receives the command transmitted actively from the relay server 200 by using the push-type communication method (S18 in FIG. 6). When the printer 100 transitions from the offline state to the online state, the printer 100 transmits the storage command request to the relay server 200 and receives the command from the relay server 200 by using the pull-type communication method (S415 and S420 in FIGS. 5, S78 and S80 in FIG. 8, and S78A and S80A in FIG. 11). The printer 100 determines whether there is an unreceived command in the relay server 200 (S435 in FIG. 5, and S82A and S88A in FIG. 11), and repeatedly transmits the storage command request to the relay server 200 by using the pull-type communication method until it is determined that there is no unreceived command in the relay server 200 (S415 and S440 in FIG. 5, and S82A and S88A in FIG. 11).

When the printer 100 is in the offline state, even if the relay server 200 actively transmits the command by the push-type communication method, the printer 100 may not be able to receive the command. According to the above-described embodiment, when the printer 100 transitions from the offline state to the online state, the printer 100 transmits the storage command request and receives the command from the relay server 200 by using the pull-type communication method. As a result, the printer 100 receives the command that has not been received during the offline state. Further, the printer 100 determines whether there is an unreceived command in the relay server 200, and repeatedly transmits the storage command request to the relay server 200 until it is determined that there is no unreceived command in the relay server 200. This suppresses reception omission of the command. Accordingly, transmission reliability of the command to be transmitted from the relay server 200 to the printer 100 is improved.

When the printer 100 is in the online state, the printer 100 receives the command transmitted actively from the relay server 200 by using the push-type communication method as described above. Thus, for example, in the online state, the main processing portion CT of the printer 100 receives the command without frequently transmitting a command request to the relay server 200 and without delay.

According to the present embodiment, when the printer 100 receives the command as the response to the storage command request by using the pull-type communication method, the printer 100 receives the information indicating the number of storage commands as the information indicating presence or absence of the unreceived command (S80A and S86A in FIG. 11). The printer 100 determines whether there is an unreceived command in the relay server 200 by using the information indicating the number of storage commands (S82A and S88A in FIG. 11, and S440 in FIG. 5). As a result, since the information indicating the number of storage commands when the command is received, it is determined whether there is an unreceived command in the relay server 200, by using this information.

According to the present embodiment, when the printer 100 receives the command by using the pull-type communication method (YES in S425 in FIG. 5), the printer 100 performs the command handling process including the process (for example, a printing process) based on the command received by using the pull-type communication method (S430 in FIG. 5). After the printer 100 performs the command handling process including the process based on the command received by using the pull-type communication method, the printer 100 performs the command handling process including the process based on an unprocessed command received by using the push-type communication method (S455 in FIG. 5). As a result, for example, after the printer 100 performs the process based on the command that has not been received from the relay server 200 by the push-type communication method due to the offline state, the printer 100 performs the process based on the command received by the push-type communication method after the printer 100 transitions to the online state. Accordingly, the printer 100 performs the process based on the command in an appropriate order.

As shown in FIG. 10, when no other command is stored in the relay server 200 (NO in S530 in FIG. 10), the relay server 200 (control portion CP) transmits the command based on the new command transmission instruction to the printer 100 by the push-type communication method by using the MQTT communication portion MP (S540 in FIG. 10). When another command is stored in the relay server 200 (YES in S530 in FIG. 10), the relay server 200 does not transmit the command based on the new command transmission instruction to the printer 100 by the push-type communication method. In other words, while a command is stored in the relay server 200, the relay server 200 transmits the command to the printer 100 by using the pull-type communication method, and does not transmit the command to the printer 100 by using the push-type communication method. When the command transmission instruction is newly received while no other command is stored in the relay server 200, the relay server 200 transmits the command to the printer 100 by using the push-type communication method. Thus, the printer 100 first performs the process based on the command received by using the pull-type communication method, and then performs the process based on the command received by using the push-type communication method as described above. Accordingly, the printer 100 performs the process based on the commands in the order in which the relay server 200 receives the command transmission instructions.

According to the present embodiment, the printer 100 transmits the storage command request including the upper limit number of commands N to the relay server 200 by using the pull-type communication method (S78A in FIG. 11), and receives, as one response to the storage command request, the storage presence notification including the number of commands corresponding to the upper limit number of commands N from the relay server 200 (S80A in FIG. 11). As a result, the printer 100 receives the number of commands corresponding to the upper limit number of commands N from the relay server 200 as one response. As a result, for example, by designating an appropriate upper limit number of commands N in terms of a memory capacity and processing performance of the printer 100, the appropriate number of commands are received in one response. Thus, the plurality of commands are received efficiently.

According to the present embodiment, the printer 100 transmits the notification relating to the command (specifically, the acquisition notification and the execution result notification) to the relay server 200 when performing the process based on the command (S38 and S48 in FIG. 7, and S98 and S108 in FIG. 9). As a result, the relay server 200 confirms that the transmitted command has reached the printer 100, and the process based on the command is performed by the printer 100.

According to the present embodiment, the printer 100 transmits the notification relating to the command (the acquisition notification and the execution result notification) according to a communication protocol (HTTP in the present embodiment) different from MQTT. As a result, for example, regarding both of a command received according to MQTT and a command received according to HTTP, when the printer 100 performs a process based on the command, the printer 100 transmits a notification relating to the command to the relay server 200 in a similar manner.

According to the present embodiment, among the notifications relating to the command, the acquisition notification (S34 and S38 in FIG. 7) includes the command ID and the information indicating the status of the command (information indicating that the command has been acquired by printer 100). In response to receiving the acquisition notification, the relay server 200 updates the status of the command from the accepted state to the delivered state (S42 in FIG. 7). When the status is updated from the accepted state to the delivered state, it is determined that the command is not the command to be transmitted to the printer 100 (non-transmitted command). Thus, the acquisition notification is used for the relay server 200 to exclude the command from the data to be transmitted to the printer 100. This suppresses the relay server 200 from redundantly transmitting the command to the printer 100.

According to the present embodiment, when the printer 100 receives the command transmitted actively from the relay server 200 by the push-type communication method (S18 in FIG. 6), the printer 100 transmits the reception notification to the relay server 200 by the push-type communication method (S22 in FIG. 6). Even when the reception notification is received, the relay server 200 does not update the status of the command from the accepted state to the delivered state. Thus, the reception notification is not used to exclude the command from the data to be transmitted to the printer 100.

For example, by transmitting the reception notification of the command to the relay server 200 by MQTT that is the push-type communication method, the printer 100 suppresses the same command from being transmitted a plurality of times by MQTT. The reception notification is not used to exclude the command from the data to be transmitted to the printer 100. Thus, when the printer 100 transmits the storage command request to the relay server 200 by the pull-type communication method (HTTP in the present embodiment), the same command is received from the relay server 200. Even if the MQTT processing portion MT of the printer 100 receives the command and returns the reception notification, for example, if the printer 100 restarts before the command is passed to the instruction processing portion PT through the main processing portion CT and the command is executed, the command may be lost. For example, in a case where the main processing portion CT or the instruction processing portion PT is in a high load state due to the process of another command (for example, a printing process), even when the MQTT processing portion MT receives the command, the main processing portion CT or the instruction processing portion PT may not immediately receive the command. This increases a risk of losing the command. Thus, if the command is excluded from the data to be transmitted to the printer 100 in response to reception of the reception notification, the main processing portion CT or the instruction processing portion PT may not receive the command, and the process based on the command may not be performed in the printer 100. In the present embodiment, the reception notification in S22 in FIG. 6 is not used for the relay server 200 to exclude the command from the data to be transmitted to the printer 100. The acquisition notification in S34 and S38 in FIG. 7 transmitted when the instruction processing portion PT performs the process based on the command is used for the relay server 200 to exclude the command from the data to be transmitted to the printer 100. As a result, transmission reliability of the command to be transmitted from the relay server 200 to the printer 100 is further improved, and the printer 100 reliably performs the process (for example, a printing process) based on the command received from the relay server 200.

According to the present embodiment, the printer 100 sets the processing flag PF to ON while the instruction processing portion PT performs the process based on the command received by using the pull-type communication method (S90 in FIG. 9, and S110 in FIG. 9). While the processing flag PF is ON, transmission of the storage command request by the pull-type communication method (S415 in FIG. 5), and the command handling process for another command (S430 in FIG. 5) are prohibited (NO in S410 in FIG. 5). Prohibition of the command handling process for another command means prohibition of the process based on another command (for example, a printing process based on another command). When the processing flag PF is returned to OFF (S110 in FIG. 9) after the process based on one command is completed, transmission of the storage command request by the pull-type communication method (S415 in FIG. 5) and the command handling process for another command (S430 in FIG. 5) are resumed (YES in S410 in FIG. 5). As a result, the processing of commands is performed one at a time in an appropriate order.

While the instruction processing portion PT performs the process based on the command received by using the push-type communication method, the processing flag PF is kept OFF without being set to ON. The processing flag PF is set to ON when the process based on the command received by using the pull-type communication method is performed. The reason is as follows. The command received by using the push-type communication method is excluded from the data to be transmitted (S42 in FIG. 7) when the relay server 200 receives the acquisition notification (S34 and S38 in FIG. 7) transmitted when the instruction processing portion PT performs the process based on the command. In contrast, the command received by using the pull-type communication method is immediately excluded from the data to be transmitted (S82 in FIG. 8) at the time point when the command is transmitted from the relay server 200 to the printer 100 (S80 in FIG. 8). Thus, the process based on the command received by using the pull-type communication method is performed immediately after the printer 100 receives the command. This is because the command received by using the pull-type communication method cannot be received again, and if the command is lost during a period after the printer 100 receives the command until the process based on the command is performed, the process based on the command is not performed. Thus, in the present embodiment, the command received by using the pull-type communication method is performed every time one command is received. For this reason, while the instruction processing portion PT performs the process based on the command received by using the pull-type communication method, the processing flag PF is set to ON, and transmission of the storage command request and execution of the command handling process for another command are prohibited.

The relay server 200 according to the present embodiment stores the command in the management database DBm in association with the status information (S14 in FIGS. 6 and S64 in FIG. 8). The relay server 200 transmits the command to the printer 100 according to MQTT that is the push-type communication method (S18 in FIG. 6). The relay server 200 transmits the command associated with the status information indicating the accepted state, among the commands stored in the management database DBm, to the printer 100 according to HTTP that is the pull-type communication method (S80 in FIG. 8). When the relay server 200 transmits the command to the printer 100 by using the push-type communication method (S18 in FIG. 6), and then receives the acquisition notification transmitted from the printer 100 (S38 in FIG. 7), the relay server 200 updates the status information of the command from the information indicating the accepted state to the information indicating the delivered state (S42 in FIG. 7). Further, when the relay server 200 receives the storage command request transmitted from the printer 100 (S78 in FIG. 8), the relay server 200 transmits the command associated with the status information indicating the accepted state (that is, the command that has not been delivered to the printer 100) to the printer 100 by using the pull-type communication method in response to the storage command request (S80 in FIG. 8).

When transmission of the command by the push-type communication method fails, no acquisition notification from the printer 100 is received. Thus, the command is transmitted to the printer 100 by the HTTP communication portion HP in response to the storage command request from the printer 100. This improves transmission reliability of the command to the printer 100 while using the push-type communication method for the communication between the relay server 200 and the printer 100.

This is described in more detail. In the push-type communication method, the relay server 200 actively transmits the command to the printer 100. When the printer 100 is not ready for reception at that time, the printer 100 may not be able to receive the command. Even when the printer 100 receives the command, in a case where failure occurs in the main processing portion CT or the instruction processing portion PT or a load is high at that time, the main processing portion CT or the instruction processing portion PT may not be able to acquire the command properly. In such a case, in order to deliver the command to the printer 100, the relay server 200 transmits the command to the printer 100 again.

In the pull-type communication method, the command is transmitted to the printer 100 in response to the storage command request from the printer 100. Thus, the relay server 200 more reliably transmits the command to the printer 100 when the printer 100 is ready to acquire the command.

In the push-type communication method, a transmission delay of a command does not tend to occur as described above, as compared with the pull-type communication method. For example, in order to reduce delay in the pull-type communication method, it is necessary for the printer 100 to perform polling at short intervals, and it is also necessary for the control portion CP of the relay server 200 to respond to the polling. Thus, the load on the printer 100 or the relay server 200 may be excessively increased.

In the present embodiment, the command that has not been transmitted to the printer 100 in the push-type communication method is transmitted to the printer 100 by using the pull-type communication method. As described above, the command is transmitted with low load and low delay by using the push-type communication method, as well as the command is reliably transmitted to the printer 100 by using the pull-type communication method.

As can be seen from the above description, the MQTT processing portion MT of the present embodiment is an example of a first communication portion, the main processing portion CT is an example of a second communication portion and a controller, and the instruction processing portion PT is an example of an execution portion. The storage command request of the present embodiment is an example of a request signal, and the command is an example of target data. The relay server 200 of the present embodiment is an example of an external device.

While the present disclosure has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the present disclosure, and not limiting the present disclosure. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described present disclosure are provided below.

(1) In the above-described embodiment, the push-type communication method is implemented by MQTT, and the pull-type communication method is implemented by HTTP. Alternatively, both the push-type communication method and the pull-type communication method may be implemented by MQTT.

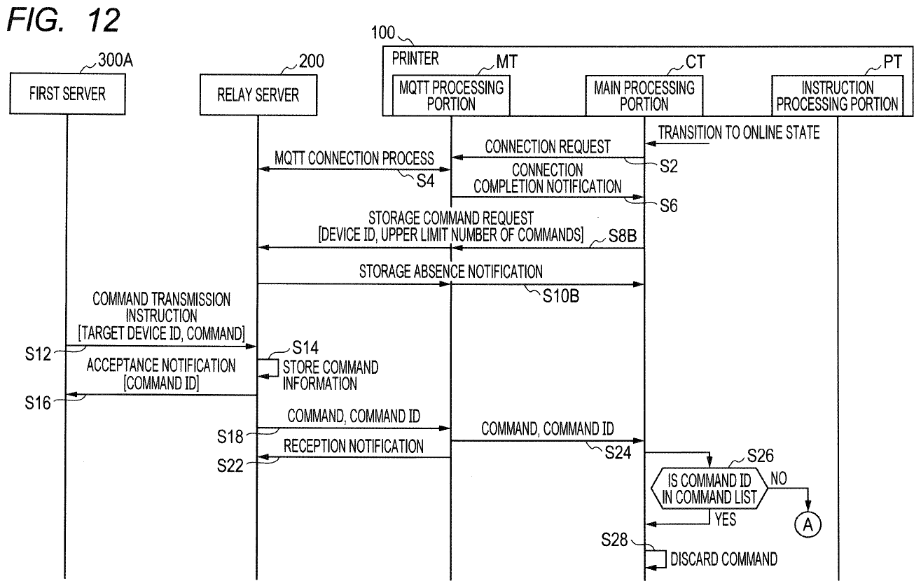

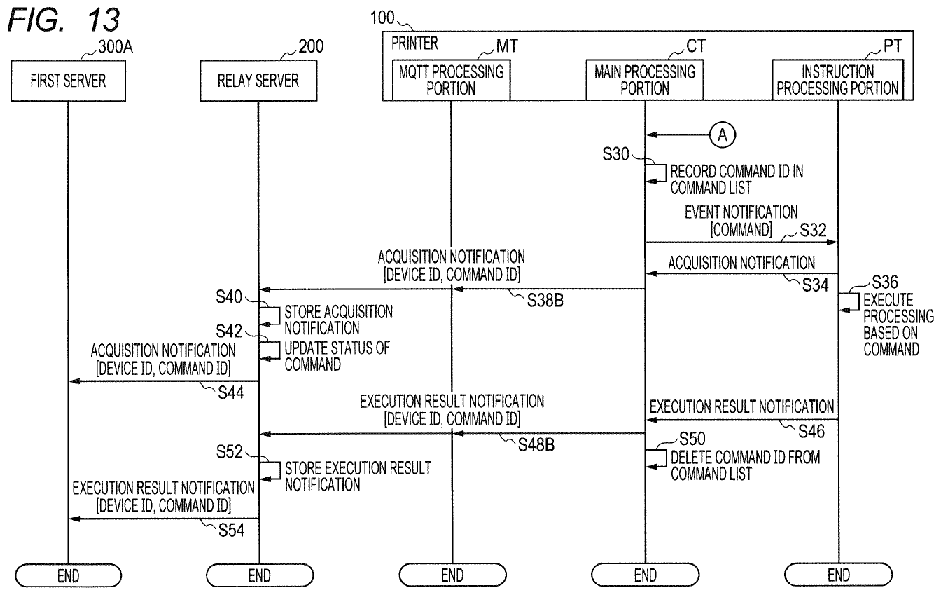

FIGS. 12 and 13 are sequence diagrams showing an operation example of a system according to a modification. For example, FIGS. 12 and 13 show an operation example in a case where the printer 100 is in the subscribed state when the relay server 200 accepts a command, as in FIGS. 6 and 7 of the embodiment. In the present modification, when the printer 100 is in the subscribed state, the relay server 200 is also in the subscribed state in which the relay server 200 subscribes to the topic addressed to the relay server 200.

In FIGS. 12 and 13, the communication between the relay server 200 and the printer 100 performed by HTTP in FIGS. 6 and 7 is performed by MQTT. Specifically, in FIG. 12, S8B and S10B are executed instead of S8 and S10 in FIG. 6. In FIG. 13, S38B and S48B are executed instead of S38 and S48 in FIG. 7. The other processes in FIGS. 12 and 13 are the same as the processes denoted by the same reference numerals in FIGS. 6 and 7.

In S8B of FIG. 12, the printer 100 transmits a storage command request to the relay server 200 by communication according to MQTT. Specifically, the main processing portion CT of the printer 100 generates a storage command request and sends the storage command request to the MQTT processing portion MT of the printer 100. The MQTT processing portion MT transmits a publish request including the storage command request to the relay server 200. In response to receiving the publish request, the MQTT communication portion MP of the relay server 200 sends the publish request to the control portion CP of the relay server 200. In this way, the storage command request is transmitted from the printer 100 to the relay server 200 (the control portion CP) as a topic addressed to the relay server 200.

In S10B of FIG. 12, the relay server 200 transmits a storage absence notification to the printer 100 in response to the storage command request, by communication according to MQTT. Specifically, the control portion CP of the relay server 200 generates a storage absence notification in response to the storage command request, and sends a publish request including the storage absence notification to the MQTT communication portion MP. The publish request includes a topic name addressed to the printer 100. In response to receiving the publish request, the MQTT communication portion MP transmits the storage absence notification to the printer 100.

As described above, although MQTT itself is not a pull-type communication protocol, a pull-type communication method is realized in which the storage command request is transmitted from the printer 100 to the relay server 200 and the storage absence command (notification) or the storage presence command (notification) is transmitted from the relay server 200 to the printer 100 as a response to the storage command request by using MQTT.

In the present modification, the printer 100 also transmits a notification regarding a process based on a command to the relay server 200 by communication according to MQTT. For example, in S38B of FIG. 13, the printer 100 transmits an acquisition notification to the relay server 200 by communication according to MQTT. Similarly, in S48B of FIG. 13, the printer 100 transmits an execution result notification to the relay server 200 by communication according to MQTT.

Although not shown, in the present modification, the storage command requests in S78 of FIG. 8 and in S78A, S84A of FIG. 11 are also transmitted by communication according to MQTT. Further, the storage presence notifications in S80 of FIG. 8 and in S80A, S86A of FIG. 11 are also transmitted by communication according to MQTT. Similarly, in the present modification, the acquisition notification in S98 of FIG. 9 and the execution result notification in S108 of FIG. 9 are also transmitted by communication according to MQTT. The processes of the present modification and the embodiment may be appropriately combined or changed. As an example, the process of S8B in the present modification may be replaced with the process of S8 in the embodiment.

(2) In the above-described embodiment, the storage presence notification to be transmitted to the printer 100 from the relay server 200 includes information indicating the number of commands stored in the relay server 200 (the number of storage commands). Alternatively, information indicating the presence or absence of a command stored in the relay server 200 may be included.

(3) Further, the information indicating the number of stored data may not be included in the storage presence notification to be transmitted to the printer 100 from the relay server 200. In this case, for example, in order to receive all the commands stored in the relay server 200, when the printer 100 receives the storage presence notification, the printer 100 processes the command included in the storage presence notification and then transmits the storage command request to the relay server 200. Then, when the printer 100 receives a storage absence notification as a response to the storage command request, the printer 100 may determine that there is no unreceived command in the relay server 200 and may not transmit any more storage command request to the relay server 200.

(4) In the above-described embodiment, even while the printer 100 receives a command in the pull-type communication method according to HTTP and executing the process based on the command, the printer 100 is able to receive a command in the push-type communication method according to MQTT. In the above-described embodiment, by processing the command received by the push-type communication method after processing the command received by the pull-type communication method, the command that has been received by actively requesting is processed first. Further, the process based on the command received by the push-type communication method may be executed after it is determined that there is no command to be received by the pull-type communication method (S440: NO), or the process based on the command received by the push-type communication method may be appropriately executed at the timing of S440: YES and S410: YES.

Instead of the embodiment, while the printer 100 receives a command by a pull-type communication method according to HTTP and executes the process based on the command, the printer 100 may be in a state where the printer 100 cannot receive a command by MQTT without subscribing to a topic by MQTT which is a push-type communication method. Even when a command is not received by the push-type communication method, commands stored in the relay server 200 are received in chronological order by the pull-type communication method, and thus the commands are received in chronological order.

(5) In the above-described embodiment, the printer 100 sets the processing flag PF to ON while executing a process based on a command received by the pull-type communication method according to HTTP, and keeps the processing flag PF to OFF while executing a process based on a command received by the push-type communication method according to MQTT. Alternatively, the processing flag PF may be set to ON while executing a process based on any command is being executed, regardless of by which communication method the command is received. Further, in a case where the main processing portion CT and the instruction processing portion PT are configured as one functional portion and a plurality of processes cannot be executed in parallel, the control using the processing flag PF may be omitted.

(6) In the above-described embodiment, the printer 100 executes a process based on a command received using the pull-type communication method first and executes a process based on a command received using the push-type communication method later, thereby executing commands such as print instructions in the order in which the printer 100 received the commands from the relay server 200. For example, depending on the type of device or the type of command, the order of executing the commands may be interchangeable. In such a case, when both of the command received by using the pull-type communication method and the command received by using the push-type communication method are received, either of the commands may be executed first.

(7) In the above-described embodiment, the printer 100 transmits two responses, that is, the acquisition notification and the execution result notification, to the relay server 200 for one command. However, the printer 100 may transmit one response to the relay server 200. For example, in a case where the command is a print instruction, it takes a certain amount of time for the printer 100 to execute printing. Thus, in this case, as in the embodiment, the acquisition notification is transmitted to the relay server 200 at the stage of receiving the command, and the execution result notification is transmitted to the relay server 200 at the stage of completing the printing. For example, in a case where the command is an instruction to transmit the remaining amount of ink, the printer 100 just reads the remaining amount of ink from the memory and transmits the remaining amount of ink, and thus the time required to execute the command is short. Thus, in this case, the printer 100 may read the remaining ink amount immediately after receiving the command and transmit the execution result notification including the remaining ink amount to the relay server 200. In this case, the acquisition notification is not transmitted to the relay server 200. Depending on the type of command, three or more responses may be transmitted to the relay server 200 in response to one command.

Regardless of the number of responses to one command, the relay server 200 may update the status information of the command from “accepted” to “delivered” when receiving the first response among one or more HTTP responses to one command.

(8) In the above-described embodiment, the status of a command may take three states, that is, accepted, delivered, and cancelled. The number of states that the status of the command may take is not limited to this, and may be two, or may be four or more. For example, in a case where the mechanism for canceling the command is not provided, the status of the command may be two types, that is, “accepted” and “delivered”. For example, the relay server 200 may have a mechanism that determines whether the printer 100 is in the online state or the offline state when the relay server 200 receives a command transmission instruction from the first server 300A, and rejects acceptance of the command transmission instruction when the printer 100 is in the offline state. In this case, the status of the command may include a state of “acceptance rejected” in addition to the three types in the embodiment.

(9) In the above-described embodiment, when the relay server 200 transmits a command to the printer 100 using the pull-type communication method, as shown in S82 of FIG. 8, the relay server 200 updates the status of the command from “accepted” to “delivered” without receiving an acquisition notification from the printer 100. Alternatively, even in a case where the command is transmitted to the printer 100 using the pull-type communication method, the relay server 200 may update the status of the command from “accepted” to “delivered” after receiving the acquisition notification from the printer 100, similarly to a case where the command is transmitted using the push-type communication method.

(10) The relay server 200 includes the information indicating the upper limit number of commands in the storage presence notification to be transmitted to the printer 100, but the information indicating the upper limit number of commands may not be included in the storage presence notification. In this case, for example, the upper limit number of commands may be set to a predetermined number, for example, a number (for example, one) that is reliably received by the printer 100 in one response.

(11) In the above-described embodiment, a communication method according to MQTT is adopted as the push-type communication method, but another push-type communication method may be adopted. Further, although the communication method according to HTTP is adopted as the pull-type communication method, another pull-type communication method may be adopted. As the push-type communication method, for example, XMPP (extensible Messaging and Presence Protocol) may be adopted. As the pull-type communication method, for example, an FTP (File Transfer Protocol) may be adopted.

(12) In the above-described embodiment, information indicating the reception date and time is used as information for specifying the storage order of commands in the command information table CDT, in other words, information for specifying the acceptance order of commands. Alternatively, the information for specifying the acceptance order of commands may be other information, for example, numbers assigned to the commands in ascending order according to the acceptance order of the commands. The numbers assigned in ascending order may also serve as command IDs, for example.

(13) In the above-described embodiment, the printer 100 is used as a device used for providing a service, but other types of devices may be employed. The device may be, for example, a scanner or a digital camera that generates image data by optically reading an object using an image sensor. The device may be, for example, a sewing machine that forms an image such as a pattern on a fabric by embroidering the fabric with a thread, or a terminal device such as a smartphone or a personal computer.

Further, the device is not limited to an image processing apparatus such as a printer, a scanner, a camera, or a sewing machine, and various devices configured to be connectable to the Internet IT may be employed. For example, the device may be a device unrelated to an image, for example, a household electrical appliance such as a refrigerator or a microwave oven, or may be a music player or a temperature sensor.

The services provided by the servers 300A, 300B may be a variety of services depending on the device employed. As the service, for example, a service that is realized by remotely operating a device by transmitting a command to the device or a service that is realized by collecting information regarding the device from the device by transmitting a command to the device may be adopted.

The target data transmitted from the servers 300A and 300B to the device via the relay server 200 is not limited to a command. The target data may be data for providing a notification or information to a user of the device, or may be data such as setting information to be stored in the device.

(14) In the above-described embodiment, in response to receiving the acquisition notification of the command transmitted from the printer 100, the relay server 200 always updates the status information of the command (S42 in FIG. 7). Alternatively, the printer 100 may add, to the acquisition notification, flag information indicating whether to update the status information. The relay server 200 may update the status information of the command when the acquisition notification includes the flag information indicating that the status information is to be updated, and may not update the status information of the command when the acquisition notification includes the flag information indicating that the status information is not to be updated. In this case, for example, when the printer 100 receives a command at the time of a high load, the printer 100 adds, to the acquisition notification, the flag information indicating that the status information is not to be updated, so that the printer 100 receives the command again later.

(15) In the above-described embodiment, a part of the configuration realized by hardware may be replaced by software, and conversely, a part or all of the configuration realized by software may be replaced by hardware.

What is claimed is:

1. A communication device comprising:
a communication interface configured to connect to a network; and
a controller configured to:
in a case where the communication device is in an online state, receive, via the communication interface, target data transmitted from an external device by a first communication method, the online state being a state in which the communication device is able to communicate with the external device via the network, the target data being data to be processed by the communication device, the first communication method being a push-type communication method;
in a case where the communication device transitions from an offline state to the online state, transmit, via the communication interface, a request signal to the external device by a second communication method, the offline state being a state in which the communication device is unable to communicate with the external device via the network, the second communication method being a pull-type communication method;
receive, via the communication interface, the target data from the external device as a response to the request signal by the second communication method;
determine whether there is unreceived target data in the external device, the unreceived target data being the target data that has not been received by the communication device; and
until determining that there is no unreceived target data in the external device, repeat transmitting the request signal to the external device by the second communication method.

2. The communication device according to claim 1, wherein the controller is configured to:
when receiving the target data from the external device as the response to the request signal by the second communication method, receive presence-absence information at least indicating presence or absence of the unreceived target data; and
determine whether the unreceived target data is stored in the external device by using the presence-absence information.

3. The communication device according to claim 1, wherein the controller is configured to:
execute a particular process based on the target data received by the second communication method; and
after executing the particular process based on the target data received by the second communication method, execute the particular process based on unprocessed target data received by the first communication method.

4. The communication device according to claim 1, wherein the controller is configured to:
transmit the request signal to the external device by the second communication method, the request signal including number information specifying a maximum number of the target data that is receivable in one response to the request signal; and
receive, from the external device, a number of the target data corresponding to the maximum number as one response to the request signal by the second communication method.

5. The communication device according to claim 3, wherein the controller is configured to:
transmit, to the external device, a notification relating to the target data when executing the particular process based on the target data.

6. The communication device according to claim 5, wherein the controller is configured to:
transmit the notification relating to the target data in accordance with a communication protocol different from a communication protocol used in the first communication method.

7. The communication device according to claim 5, wherein the notification relating to the target data includes:
identification information identifying the target data; and
information indicating a status of the target data, the status of the target data being used in the external device to exclude the target data from data to be transmitted to the communication device.

8. The communication device according to claim 5, wherein the controller is configured to:
in response to receiving the target data transmitted from the external device by the first communication method, transmit a reception notification to the external device by the first communication method, the reception notification being not used in the external device to exclude the target data from data to be transmitted to the communication device.

9. The communication device according to claim 3, wherein the controller is configured to:
while the particular process is being executed based on one target data received by the second communication method, prohibit transmission of the request signal by the second communication method and execution of the particular process based on an other target data; and
after completing the particular process based on the one target data, perform the transmission of the request signal by the second communication method or the execution of the particular process based on the other target data.

10. The communication device according to claim 1, wherein the first communication method is a communication method in accordance with MQTT (Message Queueing Telemetry Transport); and
wherein the second communication method is a communication method in accordance with HTTP (HyperText Transfer Protocol).

11. The communication device according to claim 2, wherein the controller is configured to:
receive, as the presence-absence information, a number information of the unreceived target data stored in the external device, the number information of the unreceived target data indicates the number of the unreceived target data that have been accepted by the external device and that are to be transmitted to the communication device.

12. The communication device according to claim 8, wherein the controller is configured to:
in response to receiving the target data transmitted from the external device by the second communication method and acquiring the target data by an application that processes the target data in the communication device, transmit an acquisition notification to the external device by the second communication method, the acquisition notification being used in the external device to exclude the target data from the data to be transmitted to the communication device.

13. A communication system comprising a communication device and an external device, the communication device comprising:
a first communication interface configured to connect to a network; and
a first controller,
the external device comprising:
a second communication interface configured to connect to the network;
a second controller; and
a memory configured to store target data and status information in association with each other, the status information indicating one of a plurality of states including a first state and a second state, the first state indicating that the target data is to be transmitted to the communication device, the second state being different from the first state,
the second controller configured to:
transmit, via the second communication interface, the target data to the communication device by a first communication method that is a push-type communication method; and
transmit, via the second communication interface, particular target data to the communication device by a second communication method that is a pull-type communication method, the particular target data being the target data associated with the status information indicating the first state among the target data stored in the memory,
the first controller configured to:
in a case where the communication device is in an online state, receive, via the first communication interface, the target data transmitted from the external device by the first communication method, the online state being a state in which the communication device is able to communicate with the external device via the network, the target data being data to be processed by the communication device;
in a case where the communication device transitions from an offline state to the online state, transmit, via the first communication interface, a request signal to the external device by the second communication method, the offline state being a state in which the communication device is unable to communicate with the external device via the network;
receive, via the first communication interface, the target data from the external device as a response to the request signal by the second communication method;
determine whether there is unreceived target data in the external device, the unreceived target data being the target data that has not been received by the communication device; and
until determining that there is no unreceived target data in the external device, repeat transmitting the request signal to the external device by the second communication method,
the second controller configured to:
in response to transmitting the target data to the communication device by the first communication method and then receiving a notification relating to the target data from the communication device, update the status information of the target data from information indicating the first state to information indicating the second state; and
in response to receiving the request signal from the communication device, transmit, via the second communication interface, the particular target data to the communication device by the second communication method.

14. A non-transitory computer-readable storage medium storing a set of program instructions for a communication device comprising a controller and a communication interface configured to connect to a network, the set of program instructions, when executed by the controller, causing the communication device to:
in a case where the communication device is in an online state, receive, via the communication interface, target data transmitted from an external device by a first communication method, the online state being a state in which the communication device is able to communicate with the external device via the network, the target data being data to be processed by the communication device, the first communication method being a push-type communication method;
in a case where the communication device transitions from an offline state to the online state, transmit, via the communication interface, a request signal to the external device by a second communication method, the offline state being a state in which the communication device is unable to communicate with the external device via the network, the second communication method being a pull-type communication method;
receive, via the communication interface, the target data from the external device as a response to the request signal by the second communication method;
determine whether there is unreceived target data in the external device, the unreceived target data being the target data that has not been received by the communication device; and
until determining that there is no unreceived target data in the external device, repeat transmitting the request signal to the external device by the second communication method.
